(19) United States
(12) Patent Application Publication
(10) Pub. No.: US 2011/0164108 A1
(43) Pub. Date: Jul. 7, 2011

(54) System With Selective Narrow FOV and 360 Degree FOV, And Associated Methods

(75) Inventors: Robert Matthew Bates, Erie, CO (US); Kenneth Scott Kubala, Boulder, CO (US); Alan E. Baron, Boulder, CO (US); Hans B. Wach, Longmont, CO (US)

(73) Assignee: FIVEFOCAL LLC, Boulder, CO (US)

(21) Appl. No.: 12/982,692

(22) Filed: Dec. 30, 2010

Related U.S. Application Data
(60) Provisional application No. 61/335,159, filed on Dec. 30, 2009.

(51) Int. Cl. H04N 5/225

(52) U.S. Cl. 348/36; 348/E05.024

(57) ABSTRACT

Systems and methods image with selective narrow FOV and 360 degree FOV onto a single sensor array. The 360 degree FOV is imaged with null zone onto the sensor array and the narrow FOV is imaged onto the null zone. The narrow FOV is selectively within the 360 degree FOV and has increased magnification as compared to the 360 degree FOV.

### RELATED APPLICATIONS

This application claims priority to US Patent Application Ser. No. 61/335,159, titled “Compact Foveated Imaging Systems”, filed Dec. 30, 2009, which is incorporated herein by reference.

### GOVERNMENT RIGHTS

This invention was made with Government support under Phase I SBIR Contract No. N10PC20066 awarded by DARPA, and Phase I SBIR Contract No. W15P7T-10-C-S016 awarded by the ARMY. The Government has certain rights in this invention.

### BACKGROUND

Many imaging applications need both a panoramic wide field of view image and a narrow, high resolution field of view. For example, manned and unmanned ground, aerial, and water borne vehicles use imagers mounted on the vehicle to assist with situational awareness, navigation obstacle avoidance, 2D and 3D mapping, threat identification and targeting, and other tasks that require visual awareness of the vehicle's immediate and distant surroundings. Certain tasks undertaken by these vehicles also have opposing visual requirements: on the one hand, a wide angle or a panoramic field of view of 180 to 360 degrees along the horizon is desired to assist with general situational awareness (including vehicle operations such as obstacle avoidance, route planning, threat assessment and mapping); while on the other hand, a high resolution image in a narrow field of view is desired to discriminate threats from potential targets, identify persons and weaponry, so as to evaluate risks of navigational hazards or other factors.

Ideally the resolution of a narrow field of view is achieved over a wide panoramic field of view. While this enhanced vision is desirable, limitations such as cost, size, weight, and power constraints make this impractical.

Panoramic imaging systems having extremely wide fields of view from 180 deg to 360 degree along one axis have become common in applications such as photography, security, and surveillance among other applications. There are three primary methods of creating 360 degree panoramic images: the use of multiple cameras, wide field fisheye or catadioptric lenses, or scanning systems.

FIG. 1 shows a prior art multiple camera system 100 for panoramic imaging that has seven cameras 102(1)-(7), each formed with lenses 104 and an imaging sensor 106, and arranged in a circle format as shown. FIG. 2 shows another prior art multiple camera system 200 for panoramic imaging that has seven cameras 202(1)-(7), each formed with lenses 204, an imaging sensor 206, and a mirror 208. FIG. 3 shows a panoramic image 300 formed using the prior art multiple camera systems 100 and 200 of FIGS. 1 and 2, wherein individual images from each camera 102, 202 are captured and stitched together to create panoramic image 300. Since the cameras are physically mounted together, a one-time calibration is required to achieve image alignment.

One benefit of using systems 100 and 200 is that each image frame of panoramic image 300 has constant resolution, whereas single aperture techniques result in varying resolution within the sequentially-generated panoramic image. A further advantage of using multiple cameras is that the cameras may have different exposure times to adjust dynamic range according to lighting conditions within each FOV. However, such strengths are also weaknesses, since it is often difficult to adjust the stitched panoramic image 300 such that noise, white balance, and contrast are consistent with different regions of the image. The intrinsic performance of each camera varies due to manufacturing tolerances, which again results in an inconsistent panoramic image 300. The use of multiple cameras 102, 202 also has the drawbacks of using more power, increased complexity, and higher communication bandwidth requirements for image transfer.

FIG. 4 shows a prior art panoramic imaging system 400 that has a single camera 402 with a catadioptric lens 404 and a single imaging sensor 406. FIG. 5 shows a prior art image 502 formed on sensor 406 of camera 402 of FIG. 4. Image 502 is annular in shape and must be “unwarped” to generate a full panoramic image. Since system 400 uses a single camera 402, it uses less power as compared to systems 100 and 200, has inherently consistent automatic white balance (AWB) and noise characteristics, and has reduced system complexity. However, disadvantages of system 400 include spatial variation in resolution of image 502, reduced image quality due to aberrations introduced by catadioptric lens 404, and inefficient use of sensor 406 since not all of the sensing area of sensor 406 is used.

Another method for creating a 360 degree image uses an imaging system with a field of view smaller than the desired field of view and a mechanism for scanning the smaller field of view across a scene to create a larger, composite field of view. The advantage of this approach is that a relatively simple sensor can be used. In the extreme case it may be a simple line array or a single pixel, or may consist of a gimbaled narrow field of view camera. The disadvantage of this approach is that there is a tradeoff between signal to noise and temporal resolution relative to the other two methods. With this method, the panoramic field of view is scanned over a finite period of time rather than captured all at once with the other described methods. The scanned field of view can be captured in a short period of time, but with a necessarily shorter exposure and thereby a reduced signal to noise ratio. Alternatively the signal to noise ratio of the image capture can be maintained by scanning the field of view more slowly, but at the cost of reduced temporal resolution. And if the field of view is not scanned quickly enough, an object of interest might be missed in the field of view between scans. Assuming constant irradiance at the image plane and equivalent pixel sizes, the SNR is reduced by the instantaneous field of view divided by the entire field of view. The disadvantages of reduced temporal resolution are that moving objects create artifacts, it is impossible to see the entire field at a given point in time, and the scanning mechanisms continuously consume power to realize the full field of view.

### SUMMARY OF THE INVENTION

Many imaging applications, including security, surveillance, targeting, navigation, 2D/3D mapping, and object tracking have the need for wide field of view to achieve situational awareness, with the simultaneous ability to image a higher resolution, narrow field of view within the panoramic scene for target identification, accurate target location etc. All of the existing wide field of view methods present serious drawbacks when trying to both image a panoramic scene for overall situational awareness and create a high resolution within the panoramic field of view for tasks requiring greater image detail.

In one embodiment, a system has selective narrow field of view (FOV) and 360 degree FOV. The system includes a single sensor array, a first optical channel for capturing a first FOV and producing a first image incident upon a first area of the single sensor array, and a second optical channel for capturing a second FOV and producing a second image incident upon a second area of the single sensor array. The first image has higher magnification than the second image.

In another embodiment, a system with selective narrow field of view (FOV) and 360 degree FOV includes a single sensor array, a first optical channel including a refractive fish-eye lens for capturing a first field of view (FOV) and producing a first image incident upon a first area of the single sensor array, and a second optical channel including catadioptrics for capturing a second FOV and producing a second image incident upon a second area of the single sensor array. The first area has an annular shape and the second area is contained within a null zone of the first area.

In another embodiment, a method images with selective narrow FOV and 360 degree FOV. The 360 degree FOV is imaged with null zone onto a sensor array and the narrow FOV is imaged onto the null zone. The narrow FOV is selectively within the 360 degree FOV and has increased magnification as compared to the 360 degree FOV.

### BRIEF DESCRIPTION OF THE FIGURES

FIG. 1 shows a prior art multiple camera system for panoramic imaging that has seven cameras, each formed with a lens and an imaging sensor, and arranged in a circle.

FIG. 2 shows another prior art multiple camera system for panoramic imaging that has seven cameras, each formed with lenses, an imaging sensor, and a mirror.

FIG. 3 shows a panoramic image formed using the prior art multiple camera systems of FIGS. 1 and 2.

FIG. 4 shows a prior art panoramic imaging system that has a single camera with a catadioptric lens and a single imaging sensor.

FIG. 5 shows an exemplary image formed on the sensor of the camera of FIG. 4.

FIG. 6 shows one exemplary optical system having selective narrow field of view (FOV) and 360 degree FOV, in an embodiment.

FIG. 7 shows exemplary imaging areas of the sensor array of FIG. 6.

FIG. 8 shows a shared lens group and sensor of FIG. 6 in an embodiment.

FIG. 9 is a perspective view of the actuated mirror of FIG. 6, with a vertical actuator and a horizontal (rotational) actuator, in an embodiment.

FIG. 10 shows one exemplary image captured by the sensor array of FIG. 6 and containing a 360 degree FOV image and a narrow FOV image.

FIG. 11 shows one exemplary 360 degree FOV image that is derived from the 360 degree FOV image of FIG. 10 using an un-warping process.

FIG. 12 shows two exemplary graphs illustrating modulation transfer function (MTF) performance of the first and second optical channels, respectively, of the system of FIG. 6.

FIG. 13 shows one optical system having selective narrow FOV, 360 degree FOV and a long wave infrared (LWIR) FOV to provide a dual band solution, in an embodiment.

FIG. 14 is a schematic cross-section of an exemplary multi-aperture panoramic imaging system that has four 90 degree FOVs and selective narrow FOV, in an embodiment.

FIG. 15 shows the sensor array of FIG. 14 illustrating the multiple imaging areas.

FIG. 16 shows a combined panoramic and narrow single sensor imaging system that includes a primary reflector, a folding mirror, a shared set of optical elements, a wide angle optic, and a shared sensor, in an embodiment.

FIG. 17 is a graph of amplitude (distance) against frequency (cycles/second) that illustrates an operational super-resolution region bounded by lines that represent constant speed, in an embodiment.

FIG. 18 is a perspective view showing one exemplary UAV equipped with the imaging system of FIG. 6 and showing exemplary portions of the 360 degree FOV, in an embodiment.

FIG. 19 is a perspective view showing one exemplary UAV equipped with an azimuthally asymmetric FOV, in an embodiment.

FIG. 20 is a perspective view showing a UAV equipped with the imaging system of FIG. 6 and configured such that the 360 degree FOV has a slant angle of 65 degrees to maximize the resolution of images capture of the ground, in an embodiment.

FIG. 21 is a perspective view showing one exemplary imaging system that is similar to the system of FIG. 6, wherein a primary reflector is adaptive and formed as an array of optical elements that are actuated to dynamically change a slant angle of a 360 degree FOV, in an embodiment.

FIG. 22 shows exemplary mapping of an area of ground imaged by the system of FIG. 6 operating within a UAV to the 360 degree FOV area of the sensor array.

FIG. 23 shows prior art pixel mapping of a near object and a far object onto pixels of a sensor array.

FIG. 24 shows exemplary pixel mapping by the imaging system of FIG. 6 of a near object and a far object onto pixels of the sensor array, in an embodiment.

FIG. 25 shows the imaging system of FIG. 6 mounted within a UAV and simultaneously tracking two targets.

FIG. 26 shows an exemplary unmanned ground vehicle (UGV) configured with two optical systems having vertical separation for stereo imaging, in an embodiment.

FIG. 27 is a schematic showing exemplary use of the imaging system of FIG. 6 within a UAV, in an embodiment.

FIG. 28 is a block diagram illustrating exemplary components and data flow within the imaging system of FIG. 6, in an embodiment.

FIG. 29 shows one exemplary prescription for the system of FIG. 14, in an embodiment.

FIGS. 30 and 31 show one exemplary prescription for the first optical channel of the system of FIG. 6, in an embodiment.

FIGS. 32 and 33 show one exemplary prescription for the second optical channel of the system of FIG. 6, in an embodiment.

FIG. 34 shows one exemplary prescription for the narrow FOV optical channel of the system of FIG. 16, in an embodiment.

FIG. 35 shows one exemplary prescription for the panoramic FOV channel of the system of FIG. 16, in an embodiment.

FIG. 36 shows one exemplary prescription for the LWIR optical channel of the system of FIG. 13, in an embodiment.

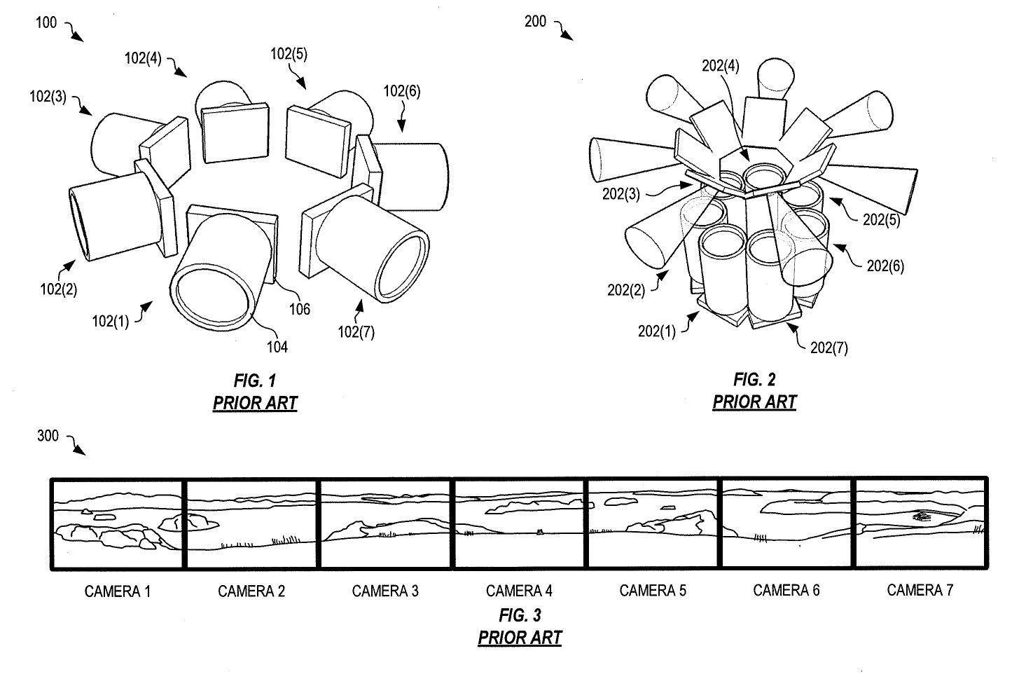

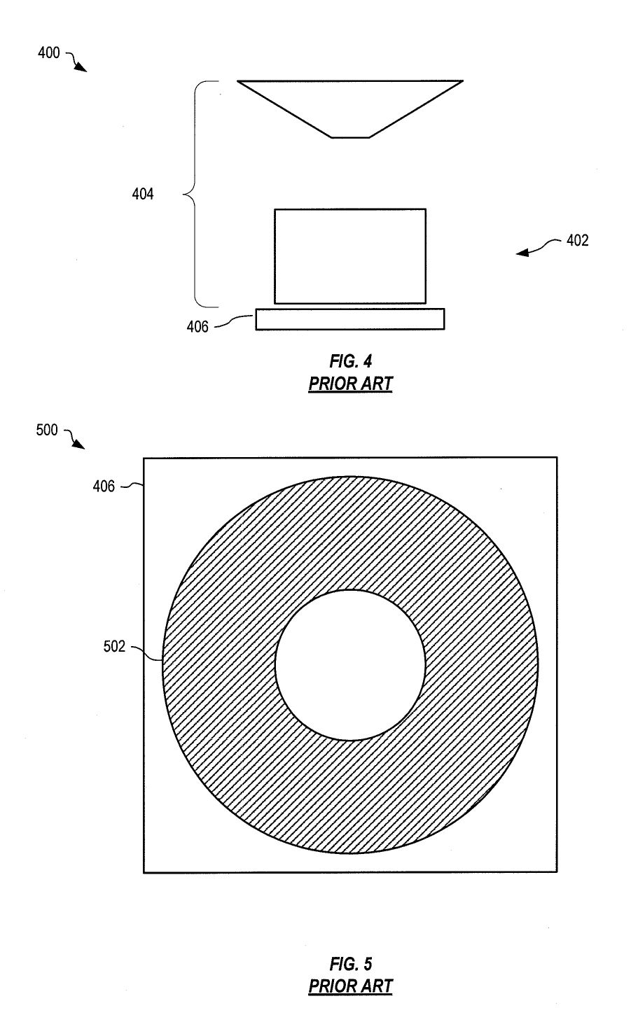

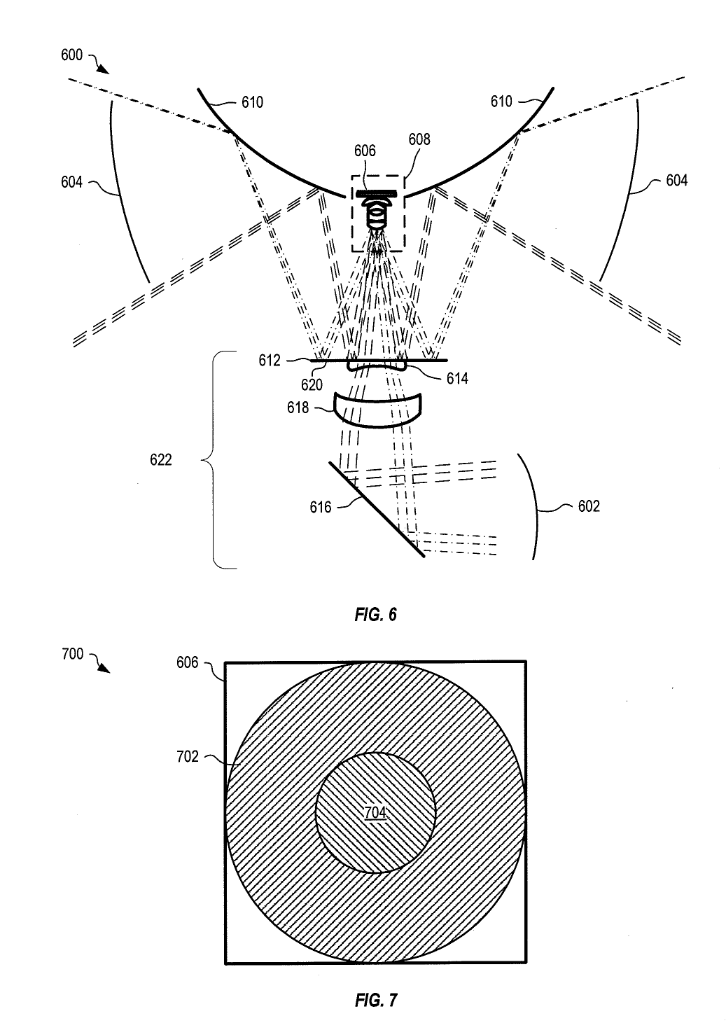

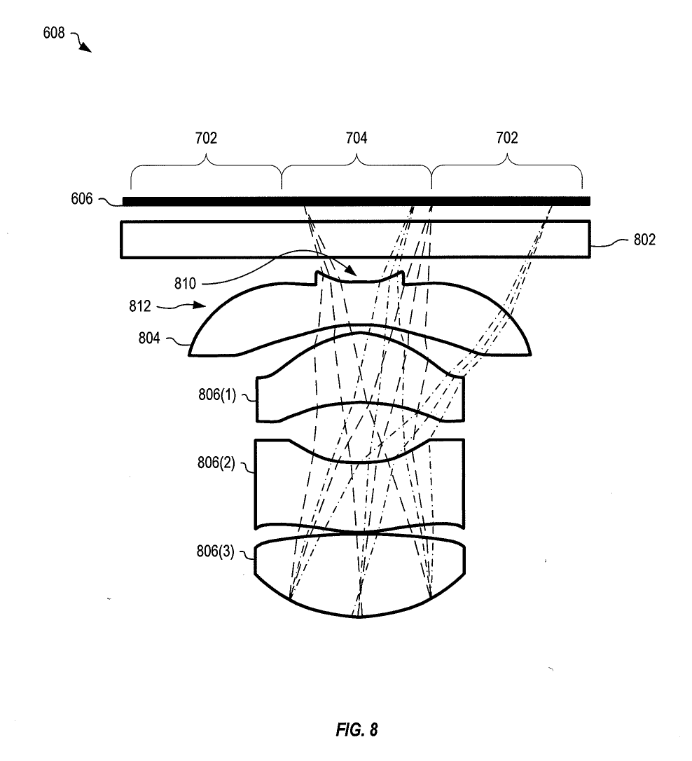

### DETAILED DESCRIPTION OF THE EMBODIMENTS

In the following descriptions, the term “optical channel” refers to the optical path, through one or more optical elements, from an object to an image of the object formed on an optical sensor array.

There are three primary weaknesses that are associated with prior art catadioptric wide field systems: image quality, varying resolution, and inefficient mapping of the image to the sensor array. In prior art catadioptric systems, a custom curved mirror is placed in front of a commercially available objective lens. With this approach, the mirror adds additional aberrations that are not corrected by the lens and that negatively influence final image quality. In the inventive systems and methods described below, this weakness is addressed by an integrated design that uses degrees of freedom within a custom camera objective lens group to correct aberrations that are introduced by the mirror.

The second prior art weakness is that the resolution of the panoramic channel varies across the vertical field. The 360 field of view is typically imaged onto the image sensor as an annulus, where the inner diameter of the annulus corresponds to 360 degrees field of view from the bottom of the imaged scene, while the outer diameter of the annulus corresponds to the top of the scene. Since the outer diameter of the annulus falls across more pixels than the inner diameter of the annulus, the top of the scene is imaged with much higher resolution than the bottom of the scene. Most prior art systems have the camera looking up and use only one mirror, resulting in the sky having more pixels allocated per degree of view than the ground. In the inventive systems and methods described below, two mirrors are used and the camera is pointing downward, such that the inner annulus corresponds to the bottom of the scene (the portion of the scene that is closer to the imager), and the outer annulus corresponds to the top of the scene (the portion of the scene that is further from the imager). By inverting the camera and using two mirrors, an improved and more constant ground sample distance (GSD) across the entire imaged scene is achieved. This is particularly useful to optimize GSD for titled plane imaging that is characteristic to imaging from low altitude aircraft, robotic platforms and security platforms, for example.

The third prior art weakness occurs because most prior art panoramic imaging systems only image a wide panoramic field of view onto a sensor array, such that the central part of the sensor array is not used. The inventive systems and methods described below combine images from a panoramic field of view (FOV) and a selective narrow FOV onto a single sensor array, wherein the selective narrow FOV is imaged onto a central part of the sensor array and the panoramic FOV is imaged as an annulus around the narrow FOV image, thereby using the detector's available pixels more efficiently.

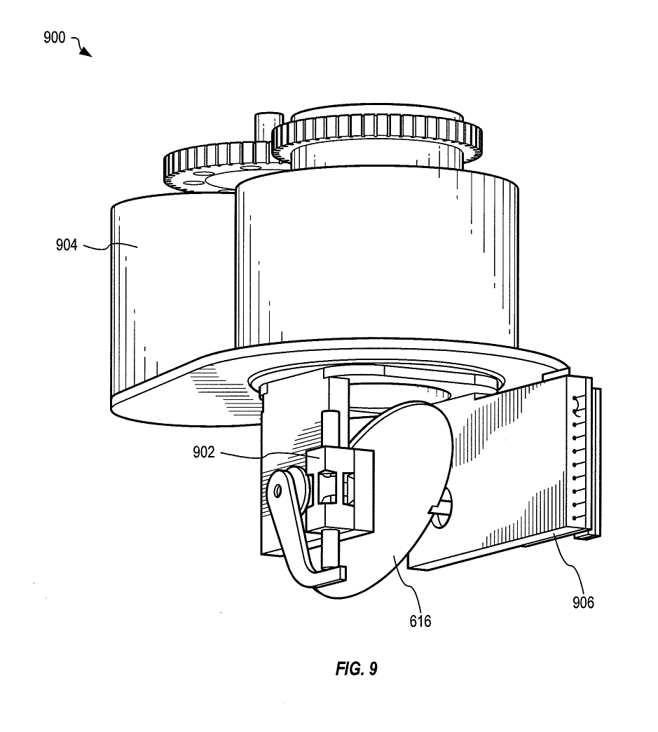

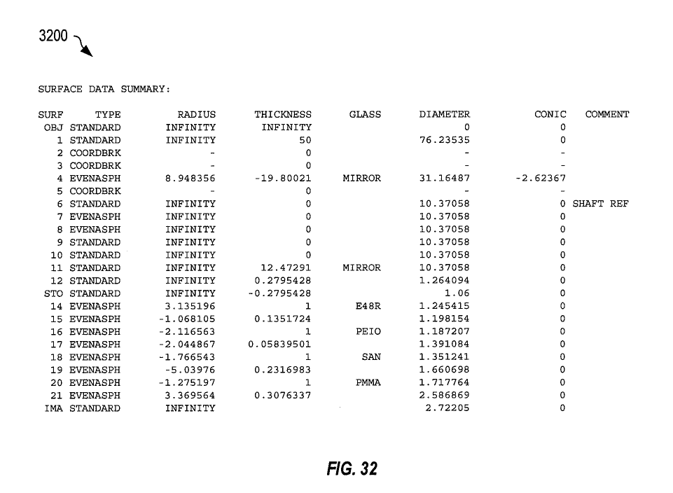

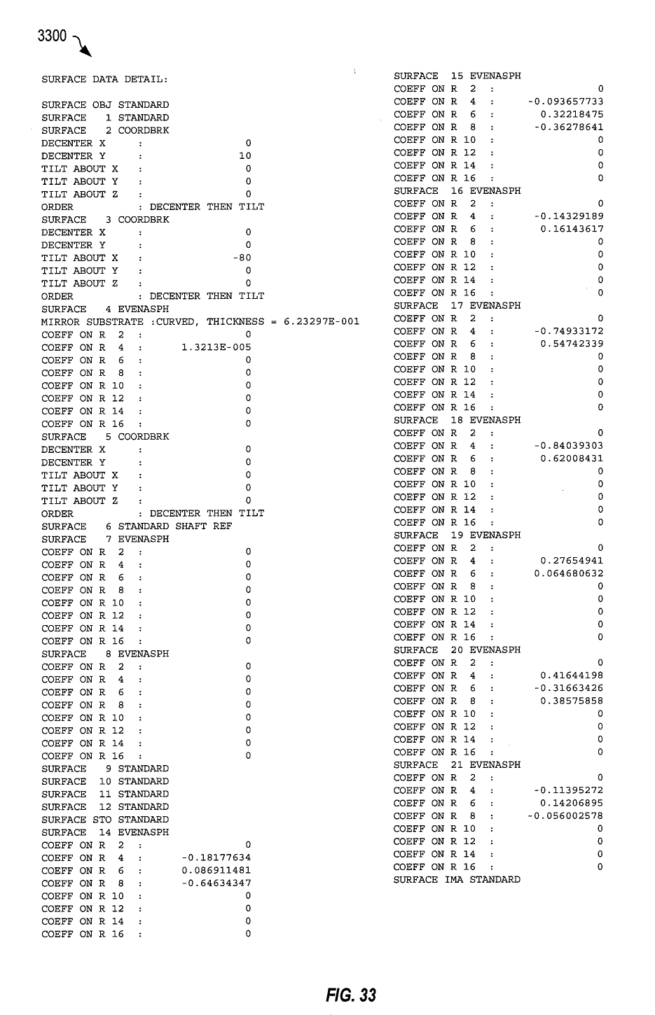

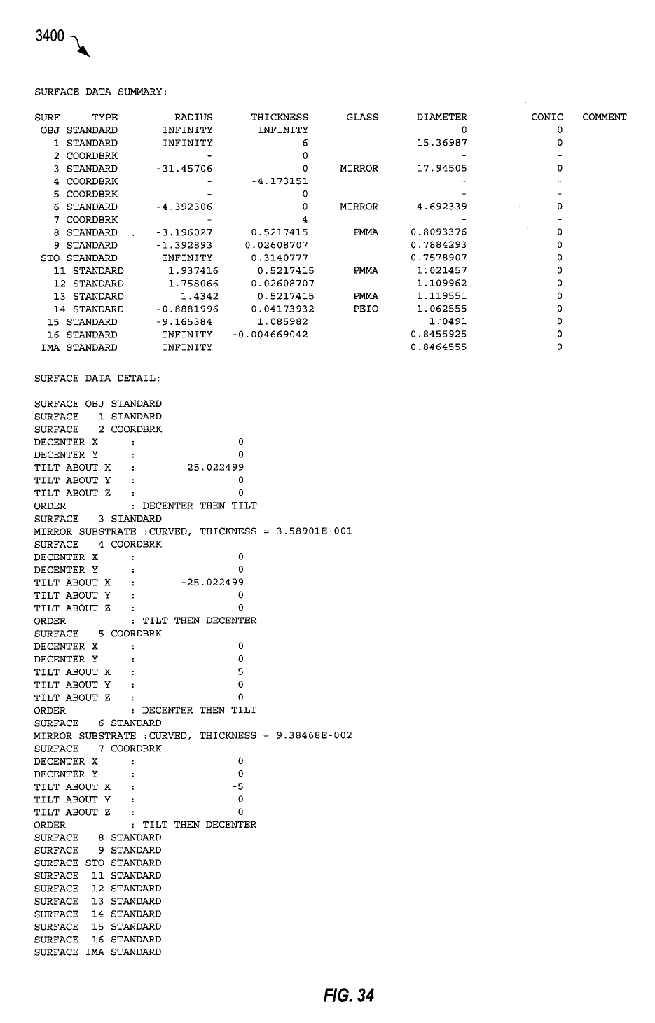

FIG. 6 shows one optical system 600 having selective narrow FOV 602 and a 360 degree FOV 604; these fields of view 602, 604 are imaged onto a single sensor array 606 of a ‘shared lens group and sensor’ 608. System 600 simultaneously provides images of multiple magnifications onto sensor array 606, wherein the narrow FOV 602 is steerable within 360 degree FOV 604 (and in one embodiment, narrow FOV 602 may be steered beyond the imaged 360 degree FOV 604). A first optical channel of narrow FOV 602 is formed by an actuated (steerable) mirror 616, a refractive lens 618, a refractive portion 614 of a combined refractive and secondary reflective element 612, and shared lens group and sensor 608. A second optical channel of FOV 604 is formed by a primary reflector 610, a reflective portion 620 of combined refractive and secondary reflective element 612, and shared lens group and sensor 608. FIGS. 30 and 31 show one exemplary prescription 3100, 3200 for the first optical channel (narrow FOV 602) of system 600. FIGS. 32 and 33 show one exemplary prescription 3200, 3300 for the second optical channel (360 degree FOV 604) of system 600. It should be noted that the shared components of shared lens group and sensor 608 appear in both prescriptions.

Primary reflector 610 may also be referred to herein as a panoramic catadioptric. Narrow FOV 602 may be in the range from 1 degree×1 degree to 50 degrees×50 degrees. In one embodiment, narrow FOV 602 is 20 degrees×20 degrees. 360 degree FOV 604 may have a range from 360 degrees×1 degree to 360 degrees×90 degrees. In one embodiment, 360 degree FOV 604 is 360 degrees×60 degrees.

The bore sight (optical axis) of narrow FOV 602 is defined by a ray that comes from the center of the field of view and is at the center of the formed image formed. For the first optical channel (narrow FOV 602), the center of the formed image is the center of sensor array 606. The bore sight (optical axis) of the second optical channel is defined by rays from the vertical center of 360 degree FOV 604 that, within the formed image, form a ring that is at the center of the annulus formed on sensor array 606. Slant angle for narrow FOV 602 and 360 degree FOV 604 is therefore measured from the bore sight to a plane horizontal to the horizon.

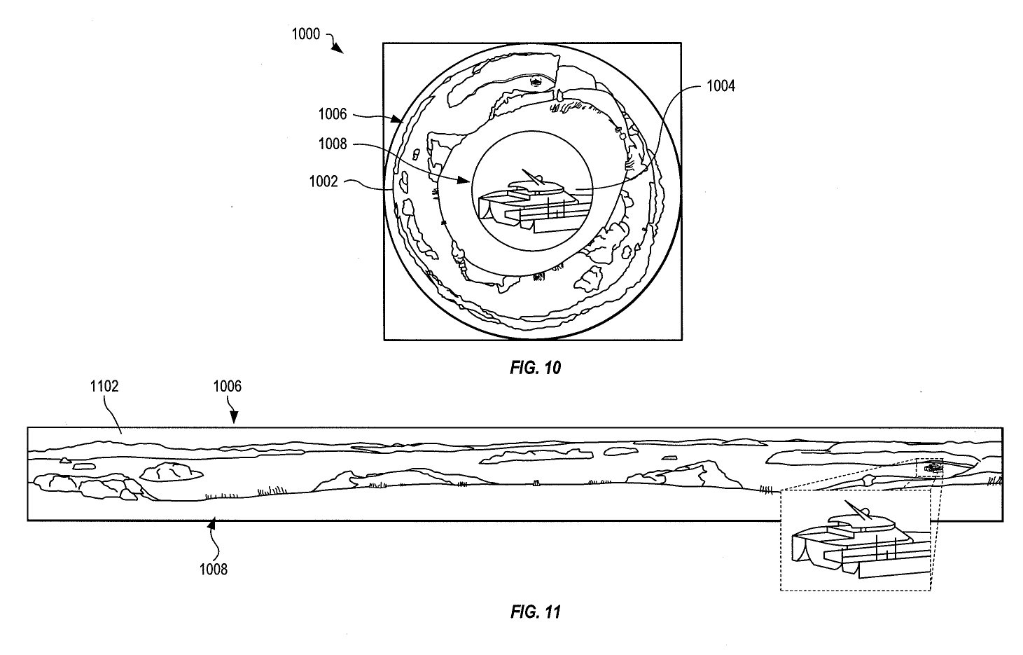

FIG. 7 shows exemplary imaging areas 702 and 704 of sensor array 606. FIG. 8 shows an embodiment and further detail of shared lens group and sensor 608, illustrating formation of a first image of the first optical channel onto imaging area 704 of sensor array 606, and formation of a second image of the second optical channel onto imaging area 702 of sensor array 606. Shared lens group and sensor 608 includes a sensor cover plate 802, a dual zone final element 804, and at least one objective lens 806. As shown in FIGS. 6 and 8, objective lenses 806 are shared between the first optical channel and the second optical channel. Dual zone final element 804 is a discontinuous lens that provides different optical power (magnification) to the first and second optical channels such that objective lenses 806 and sensor array 606 are shared between the first and second optical channels. This configuration saves weight and enables a compact solution. Dual zone final element 804 may also include at least one zone of light blocking material in between optical channels in order to minimize stray light and optical cross talk. The surface transition in FIG. 8, between the first optical channel zone and the second optical channel zone is shown as a straight line, but could in practice be curved, stepped, or rough in texture for example and could cover a larger annular region. Additionally it could use paint, photoresist or other opaque materials either alone or with total internal reflection to minimize the light that hits this region from making it to the sensor. Dual zone final element 804 also allows different and tunable distortion mapping for the first and second optical channels. Dual zone final element 804 also provides additional optical power control that enables the first and second channels to be imaged onto the same sensor array (e.g., sensor array 606). The design of system 600 leverages advanced micro plastic optics that enable system 600 to achieve low weight.

Combining refractive and secondary reflective element 612 with an outer, flat edge forming reflective portion 620, which serves as a secondary mirror to fold second optical channel FOV toward primary reflector 610, enables a vertically compact system 600. Refractive portion 614 of combined refractive and secondary reflective element 612 magnifies a pupil of the first optical channel. Injection molded plastic optics may also be used advantageously in forming dual zone final element 804 of shared lens group and sensor 608. Since the first and second optical channels are separated at dual zone final element 804, the final surface of element 804 has a concave inner zonal radius 810 and a convex outer zonal radius 812, allowing both the first and second optical channels to image a high quality scene onto areas 704 and 702, respectively, of image sensor array 606.

System 600 may be configured as three modular sub-assemblies to aid in assembly, alignment, test and integration, extension to the infrared, and customization to vehicular platform operational altitude and objectives. The three modular sub-assemblies, described in more detail below, are: (a) shared lens group and sensor 608 used by both wide and narrow channels, (b) the second optical channel primary reflector 610, and (c) first optical channel fore-optics 622 that include actuated mirror 616 and combined refractive and secondary reflective element 612.

Shared lens group and sensor 608 is for example formed with plastic optical elements 804, 806, and integrated spacers (not shown) that are secured in a single optomechanical barrel and affixed to imaging sensor array 606 (e.g., a 3 MP or other high resolution sensor). Shared lens group and sensor 608 is thus a well-corrected imaging camera objective lens group by itself and may be tested separate from other elements of system 600 to validate performance. Shared lens group and sensor 608 is inserted through a hole in the center of primary reflector 610 (which also has optical power) and aligned by referencing from a precision mounting datum. As a cost-reduction measure, shared lens group and sensor 608 may be replaced by commercial off the shelf (COTS) cameras from the mobile imaging industry with slight modifications to the COTS lens assembly to accommodate dual zone final element 804.

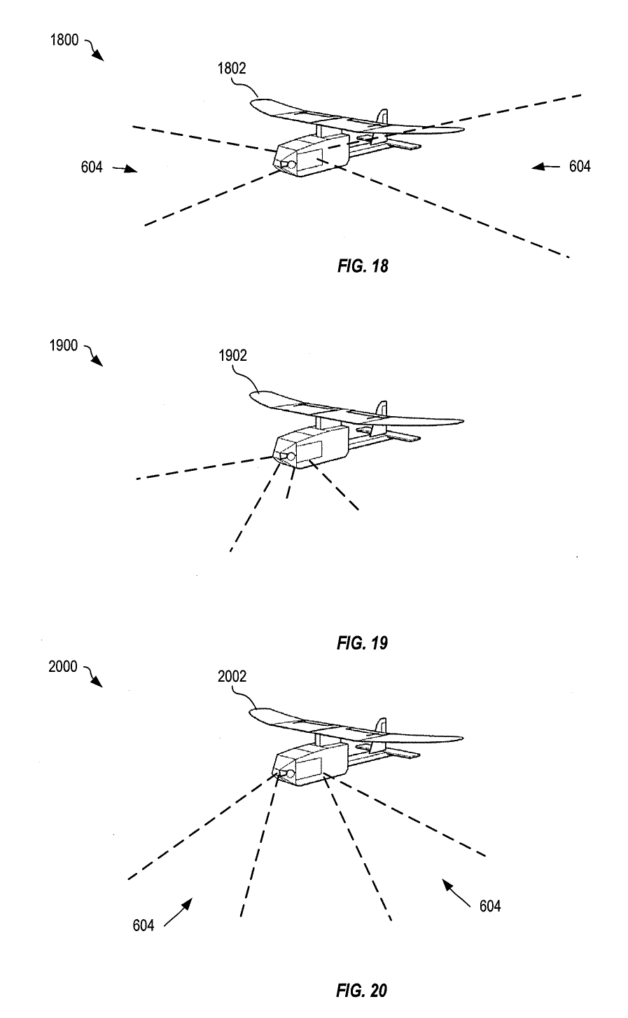

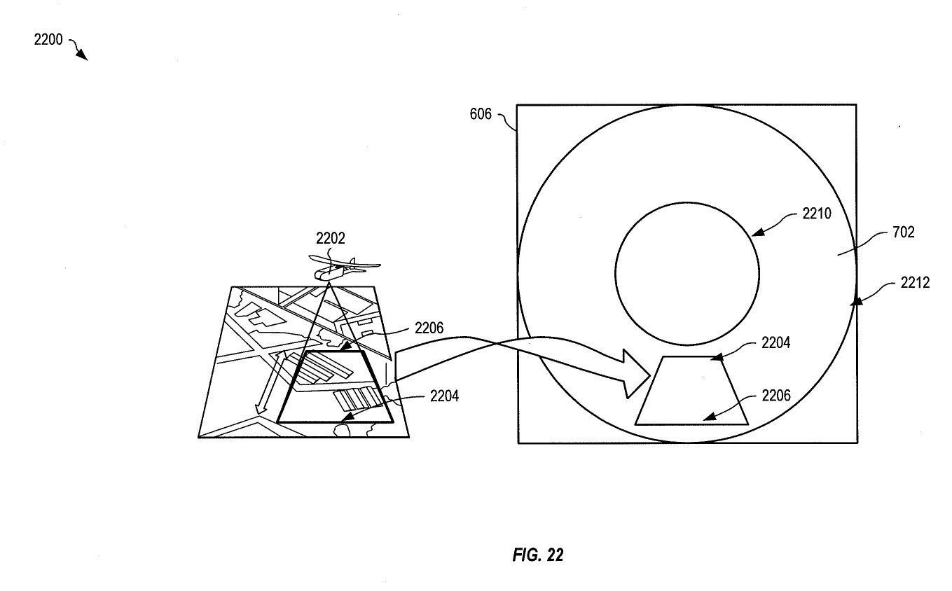

In an embodiment, primary reflector 610 includes integrated mounting features to attach the entire camera system to external housing, as well as to provide mounting features for shared lens group and sensor 608. Primary reflector 610 is a highly configurable module that may be co-designed with shared lens group and sensor 608 to customize system 600 according to desired platform flight altitude and imaging objectives. For example, primary reflector 610 may be optimized to see and avoid objects at a similar altitude as the platform containing system 600, thereby having FOV 604 with a slant angle from 0 degrees relative to the horizon or platform motion, orienting FOV 604 radially out to provide both above and below the horizon imaging to see approaching aircraft yet still provide ground imaging. FIG. 18 is a perspective view 1800 showing one exemplary UAV 1802 equipped with system 600 of FIG. 6 showing exemplary portions of 360 degree FOV 604 having above and below horizon imaging. In another example, primary reflector 610 may be optimized for ground imaging. FIG. 20 is a perspective view 2000 showing a UAV 2002 equipped with system 600 of FIG. 6 configured such that FOV 604 has a slant angle of 65 degrees to maximize the resolution of images captured of the ground. In another example, primary reflector 610 may be optimized for distortion mapping, where the GSD is reasonably constant resulting in a reasonably consistent resolution in captured images of the ground. FIG. 22 shows exemplary mapping of an area of ground imaged by system 600 operating within a UAV 2202 to area 702 of sensor array 606. As shown in FIG. 22, a position 2204 on the imaged ground that is nearer UAV 2202 (and hence system 600) is imaged nearer to an inner part 2210 of area 702 on sensor array 606. A position 2206 that is further from UAV 2202 appears more towards an outer part 2212 of area 702. Specifically, as the slant angle distance increases (i.e. from the camera to the object along the line of sight), the resolution of captured images has substantially constant resolution. Primary reflector 610 may be optimized to provide maximally sampled regions and sparsely sampled regions of FOV 604.

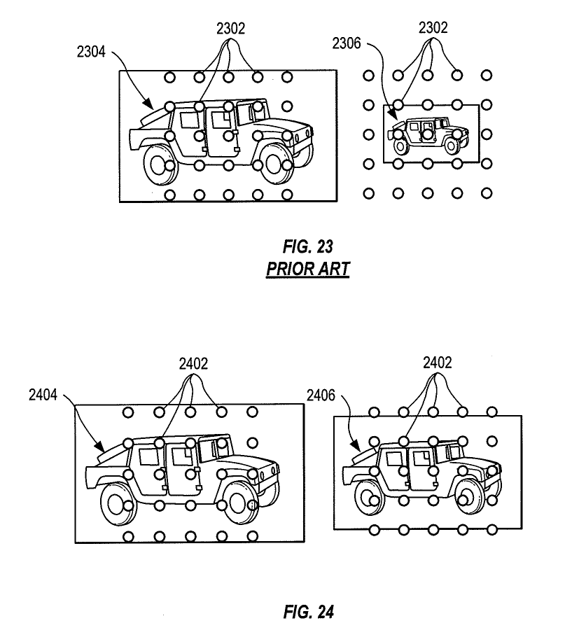

FIG. 23 shows prior art pixel mapping of a near object 2304 and a far object 2306 onto pixels 2302 of a sensor array, illustrating that the further away the object is from the prior art optical system, the fewer the number of pixels 2302 used to capture the image of the object. FIG. 24 shows exemplary pixel mapping by system 600 of FIG. 6 of a near object 2404 and a far object 2406 onto pixels 2402 of sensor array 606. Objects 2404 and 2406 are at similar distances from system 600 as objects 2304 and 2306, respectively, to the prior art imaging system. Since more distant objects are imaged by system 600 onto larger areas of sensor array 606, the number of pixels 2402 sensing the same sized target remains substantially constant.

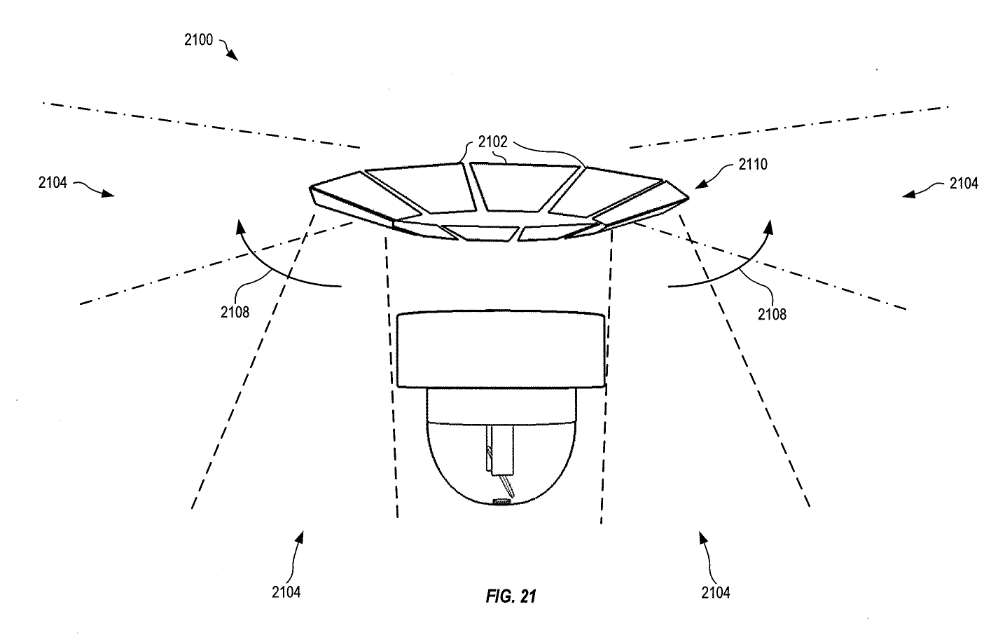

In one embodiment, primary reflector 610 is optimized such that FOV 604 is azimuthally asymmetric, such that a forward-looking slant angle is different from a side and rearward slant angles. For example, primary reflector 610 is non-rotationally symmetric. This is advantageous, for example, in optimizing FOV 604 for forward navigation and side and rear ground imaging. FIG. 19 is a perspective view 1900 showing one exemplary UAV 1902 equipped with an azimuthally asymmetric FOV.

FIG. 21 is a perspective view showing one exemplary imaging system 2100 that operates similarly to system 600, FIG. 6, wherein primary reflector 2110 is adaptive and formed as an array of optical elements 2102 actuated dynamically to change slant angle 2108 of a 360 degree FOV 2104. In one embodiment, each optical element 2102 is actuated independent of other optical elements 2102 to vary slant angle of an associated portion of 360 degree FOV 2104. In another embodiment, primary reflector 610 is a flexible monolithic mirror, whereby actuators flex primary reflector 610 such that the surface of the mirror is locally modified to change magnification in portions of FOV 604. For example, primary reflector 610 an actuator pistons primary reflector 610 where a specific field point hits the reflector such that a primarily local second order function is created to change the optical power (magnification) of that part of the reflector. This may cause a focus error that may be corrected at the image for large pistons. For small pistons, focus compensation may not be necessary. By locally actuating primary reflector 610, a local zoom through distortion is created. In another embodiment, not shown but similar to system 600 of FIG. 6, primary reflector 610 is a flexible monolithic mirror, whereby actuators tilt and/or flex the primary reflector 610 such that the slant angle is azimuthally actuated with a monolithic mirror.

First optical channel fore-optics 622 includes combined refractive and secondary reflective element 612, refractive lens 618 fabricated with micro-plastic optics and actuated mirror 616. Combined refractive and secondary reflective element 612 is for example a single dual use plastic element that includes refractive portion 614 for the first optical channel, and includes reflective portion 620 as a fold mirror in the second optical channel. By combining the refractive and reflective components into a single element, mounting complexity is reduced. Specifically, first optical channel fore-optics 622 is integrated (mounted) with actuated mirror 616 and refractive lens 618 is inset inside (mounted to) the azimuthal shaft of actuated mirror 616, reducing vertical height of system 600 as well as size (and subsequently the mass) of actuated mirror 616. First optical channel fore-optics 622 may also be tested separately from other parts of system 600 before being aligned and integrated with the full system.

FIG. 9 is a perspective view 900 of actuated mirror 616, vertical actuator 902 and horizontal (rotational) actuator 904. Actuators 902 and 904 are selected to meet actuation requirements of system 600 using available commercially off the shelf (COTS) parts to reduce cost. Mass of actuation components 902, 904, and actuated mirror 616 are low and mirror, flexures, actuators and lever arms are rated to high g-shock (e.g., 100-200 g). Actuators 902, 904 may be implemented as one or more of: common electrical motors, voice coil actuators, and piezo actuators. FIG. 9 shows actuators 902 and 904 implemented using piezo actuators from Newscale and Nanomotion. In the example shown in FIG. 9, actuator 902 is implemented using a Newscale Squiggle® piezo actuator and actuator 904 is implemented using a Nanomotion EDGE® piezo actuator. The complete steering mirror assembly weighs 20 grams and is capable of directing the 0.33 gram actuated mirror 616 anywhere within FOV 604 within 100 milliseconds. Actuators 902 and 904 may also use positional encoders 906 that accurately determine elevation and azimuth orientation of actuated mirror 616 for use in positioning of actuated mirror 616, as well as for navigation and geolocation, as described in detail below. The scan mirror assembly may use either service loops or a slip ring configuration that allows continuous rotation (not shown).

FIG. 10 shows one exemplary image 1000 captured by sensor array 606 and containing a 360 degree FOV image 1002 (as captured by area 702 of sensor array 606) and a narrow FOV image 1004 (as captured by area 704 of sensor array 606). FIG. 11 shows one exemplary 360 degree FOV image 1102 that is derived from 360 degree FOV image 1002 of FIG. 10 using an un-warping process. The outer edge 1106 of image 1002 has more pixels than an inner edge 1108, given that the array of pixels of imaging sensor array 606 is linear. Image 1002 is un-warped such that outer edge 1006 and inner edge 1008 are substantially straight, as shown in image 1102.

In one embodiment, the location of selective narrow FOV 602 within 360 degree FOV 604 is determined using image based encoders. For example, by using 360 degree FOV image 1102 and by binning image 1004 of the first optical channel (e.g., narrow channel), an image feature correlation method may be used to identify where image 1004 occurs within image 1002, thereby determining where actuated mirror 616 and the first optical channel are pointing.

In one example of operation, a person may be detected within image 1002 at a slant distance of 400 feet from system 600, and that person may be identified within image 1004. Specifically, for the same slant distance of 400 feet, a person would have a width of two pixels within image 1002 to allow detection, and that person would have a width of 16 pixels (e.g., 16 pixels per ½ meter target) within image 1004 to allow identification.

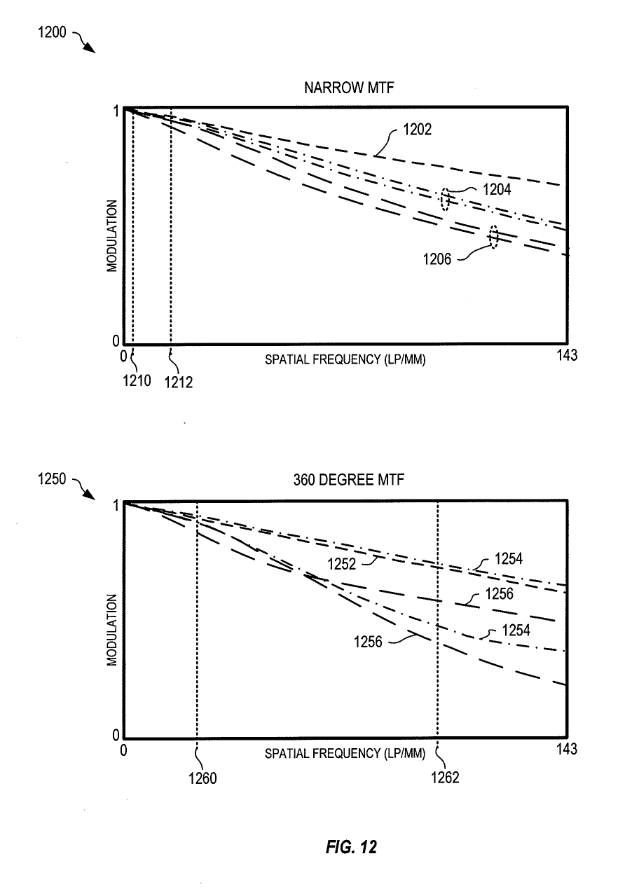

FIG. 12 shows two exemplary graphs 1200, 1250 illustrating modulation transfer function (MTF) performance of the first (narrow channel) and second (360 degree channel) optical channels, respectively, of system 600. In the example of FIG. 12, a sensor with 1.75 micron pixels is used that defines a green Nyquist frequency of 143 line pairs per millimeter (lp/mm). In graph 1200, a first line 1202 represents the MTF on axis, a first pair of lines 1204 represents the MTF at a relative field position of 0.7, and a second pair of lines 1206 represents the MTF at a relative field position of 1 (full field). A first vertical line 1210 represents a spatial frequency that is required to detect a vehicle, and a second vertical line 1212 represents a spatial frequency required to detect a person. Similarly, in graph 1250, a first line 1252 represents the MTF on axis, a first pair of lines 1254 represents the MTF at a relative field position of 0.7, and a second pair of lines 1256 represents the MTF at a relative field position of 1 (full field). A first vertical line 1260 represents a spatial frequency that is required to detect a vehicle, and a second vertical line 1262 represents a spatial frequency required to detect a person. Both graphs 1200, 1250 show high modulation for the detection of both people and vehicles within the first and second optical channels.

The resolution in the first and second optical channels is based upon the number of pixels on image sensor array 606, and areas 702, 704 into which images are generated by the channels. In general, the ratio between areas 702 and 704 is balanced to provide optimal resolution in both channels, although many other aspects are also considered in this balance. For example, the inner radius of area 702 (the second optical channel) annulus cannot be reduced arbitrarily, since decreasing this radius reduces the horizontal resolution at edge 1008 of image 1002 (in the limit as this radius is reduced to zero, edge 1008 maps to a single pixel). Also, since the first and second optical channels have different focal lengths, shared lens group and sensor 608 is designed to size the entrance pupils appropriately so that the two channel f-numbers (f/#s) are closely matched (e.g., the f/#'s are separated by less than half a stop) and are therefore not exposed differently by sensor array 606. Mismatched f/#'s causes a reduction in dynamic range of the system which is proportional to the square of the difference in the f/#'s. Further, the optical performance of the first and second optical channels supports the MTF past the Nyquist frequency of image sensor array 606, as shown in FIG. 12 by the high MTF values at 143 lp/mm where the first null occurs well beyond this spatial frequency; the resolution requirements for system 600 would not be met if system 600 were limited by the optical performance instead of image sensor array 606 performance.

It should be noted that with a typical sensor array that has square pixels, the Nyquist frequency changes as the sensor array is rotated from horizontal to vertical. In the x and y direction the pixel pitch is the same as the pixel size assuming a 100% fill factor. On the diagonals, the Nyquist frequency drops by a factor of 1/sqrt(2) assuming a 100% fill factor and square active area. The impact of this is that the resolution varies in the azimuth direction. One way of compensating for this is by using hexagonal pixels within the sensor array. Another way is to utilize the sensor's degrees of freedom to implement non-uniform sampling. For example, the second optical channel may utilize an area on the sensor array with a different pixel pitch than the area used by the first optical channel. These two areas may also have different readouts and different exposure times to achieve the same effect. A custom image sensor array may also be configured with a region in between the two active parts of the sensor that do not have pixels, thereby reducing any image based cross talk. Alignment of the pixel orientation to the optical channels is not critical, although a hexagonal pixel shape creates a better approximation to a circular Nyquist frequency than does a square pixel.

System 600 operates to capture an image within a panoramic field of view at two different focal lengths, or resolutions; this is similar to a two position zoom optical system. System 600 may thus synthesize continuous zoom by interpolating between the two resolutions captured by the first and second optical channels. This synthesized zoom is enhanced if the narrow channel provides variable resolution, which may be achieved by introducing negative (barrel) distortion into the first optical channel. The synthesized zoom may additionally benefit from super resolution techniques to create different magnifications and thereby different zoom positions. Super resolution may be enabled by using the inherent motion of objects in the captured video, by actuating the sensor position, or by actuating the mirror in the first or second optical channel.

System 600 images 360 degree FOV 604 onto an annular portion (area 702) of image sensor array 606, while simultaneously imaging a higher resolution, narrow FOV 602 within the central portion (area 704) of the same image sensor. The optical modules described above provide this combined panoramic and zoom imaging capability in a compact package. In one embodiment, the overall volume of system 600 is 81 cubic centimeters, with a weight of 42 grams, and an operational power requirement of 1.6 Watts.

Some imaging applications desire both visible wavelength images and infrared wavelength images (short wave, mid wave and long wave) to enable both night and day operation. System 600 of FIG. 6, which provides visible wavelength imaging, may be modified (in an embodiment) to cover the LWIR. For example, the focal plane may be changed, the focal lengths may be scaled, and the plastic elements may be replaced with ones that transmit a desired (e.g., LWIR) spectral band.

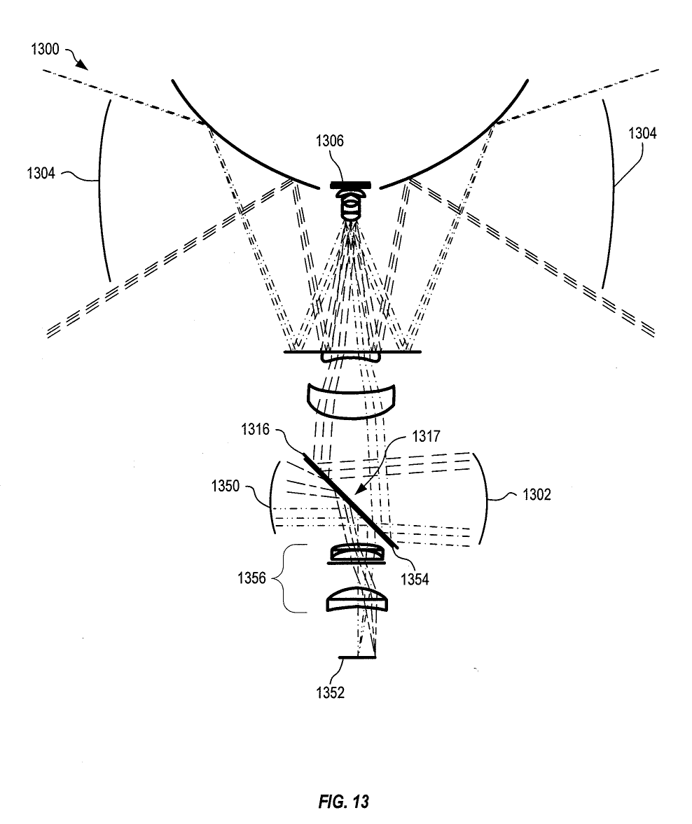

FIG. 13 shows one exemplary optical system 1300 having a selective narrow FOV 1302 and a 360 degree FOV 1304 imaged on a first sensor array 1306 and an LWIR FOV 1350 imaged onto an LWIR sensor array 1352, thereby providing a dual band solution. FIG. 36 shows one exemplary prescription 3600 for the LWIR optical channel (LWIR FOV 1350) of system 1300. The visible imaging portion of system 1300 is similar to system 600, FIG. 6, and the differences between system 1300 and system 600 are described in detail below.

Actuated mirror 1316 is similar to actuated mirror 616 of system 600 in that it has a first side 1317 that is reflective to the visible spectrum. A second side # of actuated mirror 1316 has an IR reflective coating 1354 that is particularly reflective to the LWIR spectrum. LWIR optics 1356 generate an image from LWIR FOV 1350 onto LWIR sensor array 1352. LWIR FOV 1350 and narrow FOV 1302 may be used simultaneously (and with 360 degree FOV 1304), or may be used individually. Actuated mirror 1316 (and IR reflective coating 1354) may be positioned to capture IR images using LWIR sensor array 1352 and positioned to capture visible light images using sensor array 1306. Where positioning of actuated mirror 1316 is rapid (e.g., within 100 milliseconds), capturing of images from sensor arrays 1306 and 1352 may be interleaved, wherein actuated mirror is alternately position to capture narrow FOV 1302 using sensor array 1306, and positioned to capture LWIR FOV 1350 using LWIR sensor array 1352.

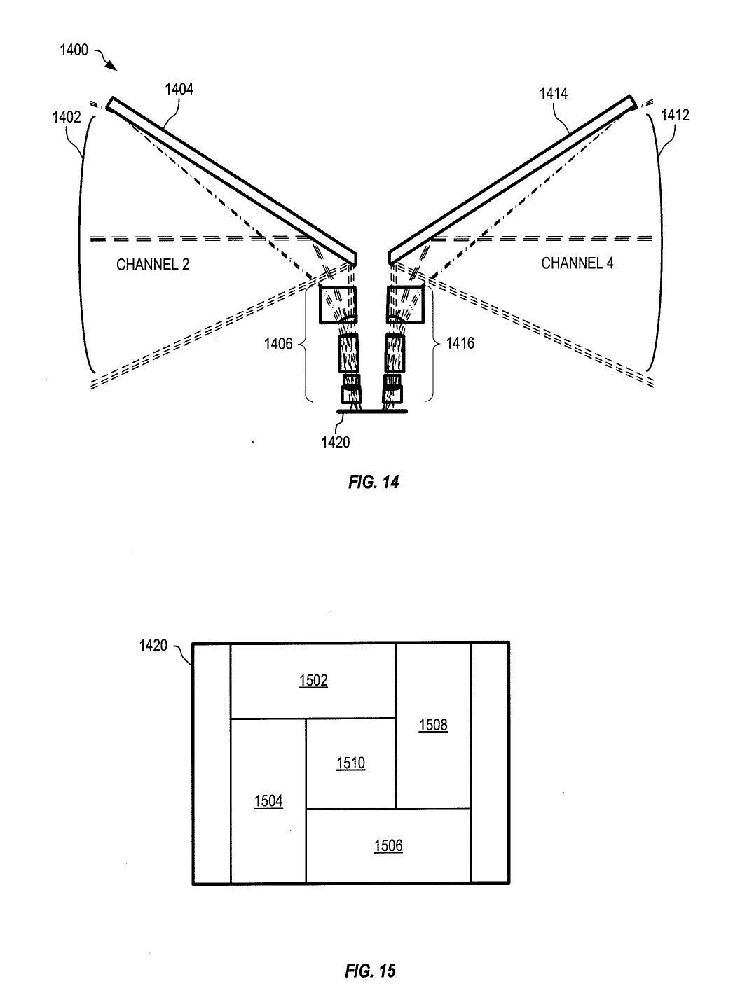

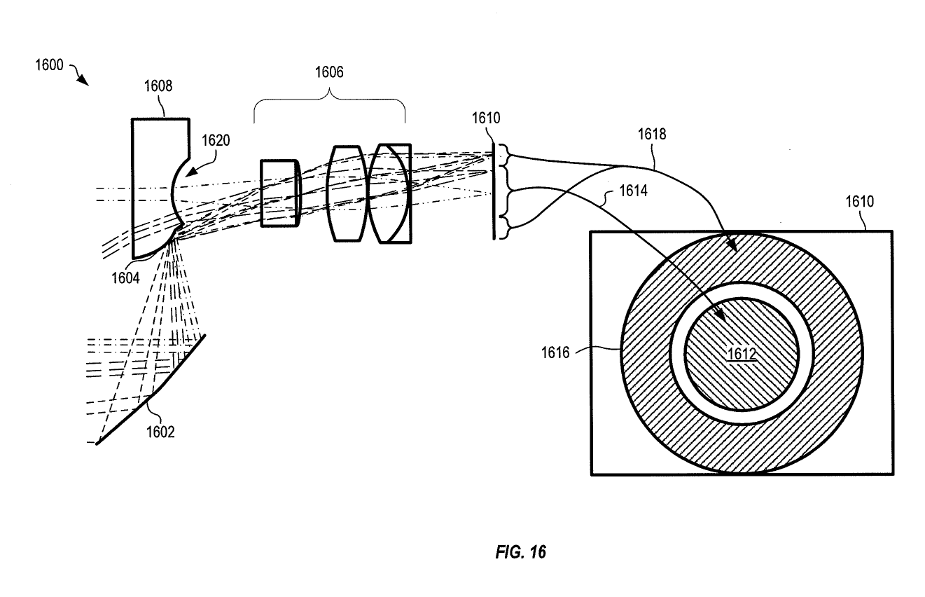

Combining panoramic FOV imaging with a selective narrow FOV imaging onto a single sensor has the advantage of lower operational power consumption and lower cost as compared to systems that use two sensor arrays. Operational power is one of the key challenges on small, mobile platforms, and there is value in packing as much onboard processing and intelligence as possible onto the platform due to the transmission bandwidth and communication latency limitations. Further, systems 600 and 1300 of FIGS. 6 and 13 respectively, are also extremely compact, thereby allowing them to fit within very small payloads. Systems 600 and 1300 may also be designed to operate within other spectral bands, including SWIR, MWIR and LWIR. FIG. 14 is a schematic cross-section of an exemplary multi-aperture panoramic imaging system 1400 that has four 90 degree FOVs (FOVs 1402 and 1412 are shown and represent panoramic channels 2 and 4, respectively) that together form the panoramic FOV that is imaged onto a single sensor array 1420 together with a selective narrow FOV. An exemplary optical prescription for system 1400 is shown in FIG. y. FIG. 15 shows sensor array 1420 of FIG. 14 illustrating imaging areas 1502, 1504, 1506, 1508, and 1510 of multi-aperture panoramic imaging system 1400. FIGS. 14 and 15 are best viewed together with the following description. FIG. 14 shows only channel 2 and channel 4 of system 1400. Channel 2 (FOV 1402) has a primary reflector 1404 and one or more optical elements 1406 that cooperate to form an image from FOV 1402 within area 1504 of sensor array 1420. Similarly, channel 4 (FOV 1412) has a primary reflector 1414 and one or more optical elements 1416 that cooperate to form an image from FOV 1402 within area 1508 of sensor array 1420. The narrow FOV, not shown in FIG. 14, is similar to that of system 600, FIG. 6, and may include one or more refractive elements and an actuated mirror that cooperate to form an image within area 1510 of sensor array 1420. Channel 1 and channel 2 of system 1400 form images within areas 1502 and 1506, respectively, of sensor array 1420.

Specifically, system 1400 illustrates an alternate method using multiple apertures and associated optical elements to generate a combined panoramic image and narrow channel image on the same sensor. Together, images captured from areas 1502, 1504, 1506 and 1508 of sensor array 1420 capture the same FOV as one or both of system 600 and 1300 of FIGS. 6 and 13, respectively. However, within system 1400, each panoramic FOV is captured with constant resolution over the vertical and horizontal field. The narrow channel is captured in a similar way to the narrow channel of systems 600 and 1300.

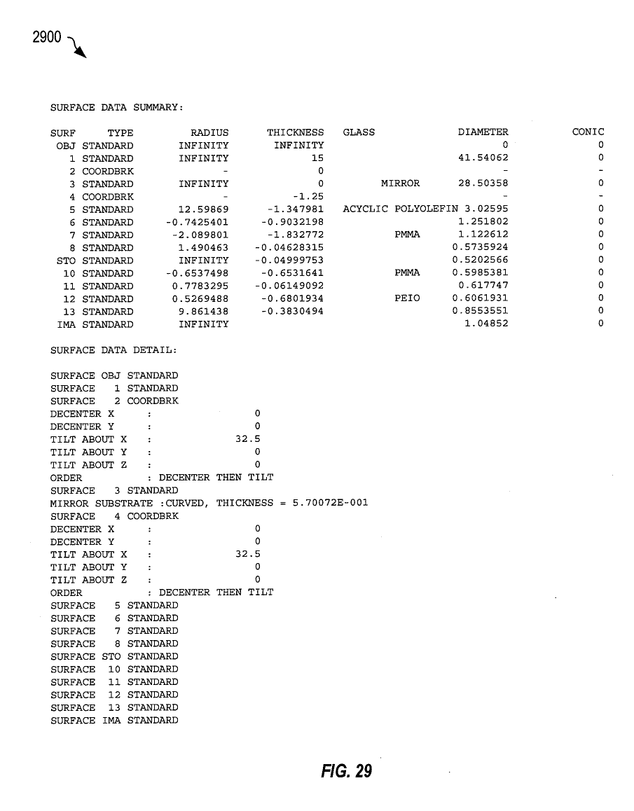

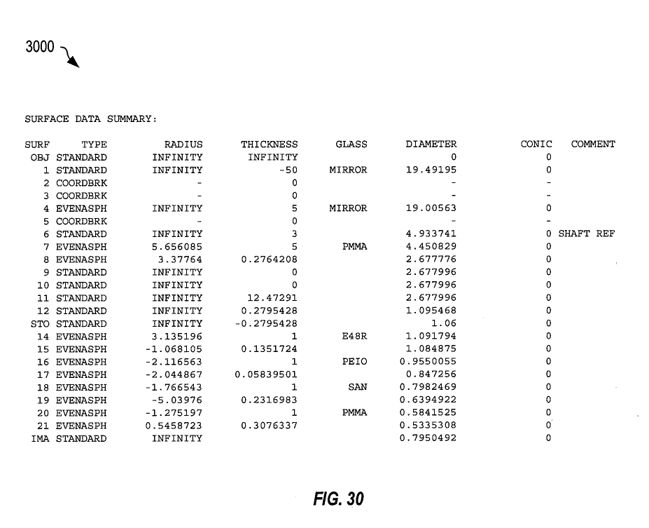

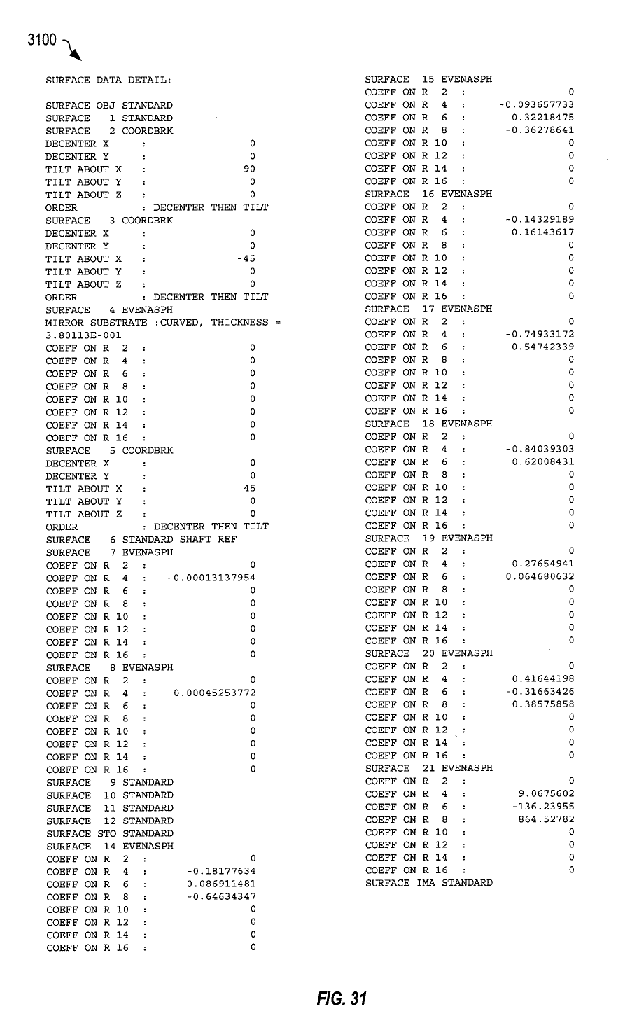

As shown in FIG. 14, the apertures are configured in an off axis geometry in order to maintain enough clearance for the narrow channel optics in the center. Due to the wide field characteristics of the optical elements 1406, 1416, there will inevitably be distortion in the images projected onto areas 1504 and 1508 (and with channels 1 and 3). This distortion would have a negative impact on generating consistent imagery in the panoramic channel, although negative distortion may be removed by the primary reflectors 1404, 1414. FIG. 29 shows one exemplary prescription 2900 for system 1400.

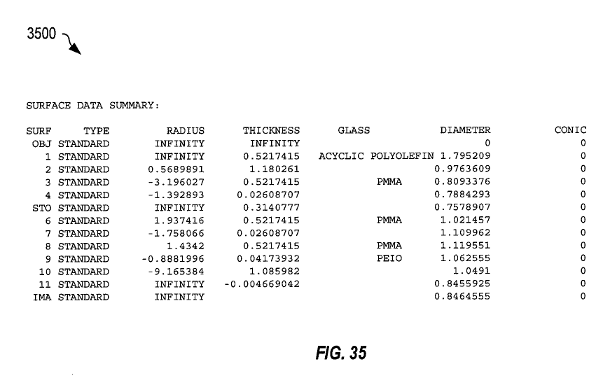

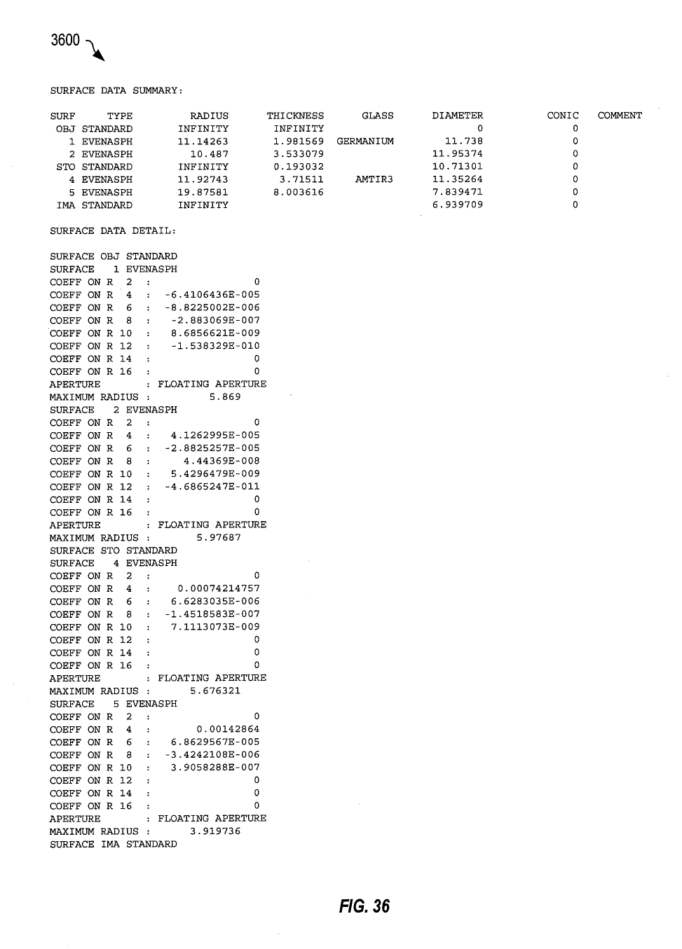

FIG. 16 shows an alternate embodiment of a combined panoramic and narrow single sensor imaging system 1600 that includes a primary reflector 1602, a folding mirror 1604, a shared set of optical elements 1606, a wide angle optic 1608, and a shared sensor array 1610. A central area 1612 of sensor array 1610 is allocated to a panoramic FOV channel 1614 and an outer annulus area 1616 of sensor array 1610 is allocated to a narrow FOV channel 1618. System 1600 may be best suited for use where the primarily image in the forward direction rather than the side directions. For system 1600, imagery in the wide channel is continuous, where as for system 600 of FIG. 6 and system 1300 of FIG. 13, there is a central region that is not imaged. Where system 600 or system 1300 is mounted with an aircraft, the region directly below the aircraft is not imaged. Where system 1600 is mounted with an aircraft, the area directly below the aircraft is imaged. Wide angle optic 1608 is a dual refractive/reflective element. The central region 1620 has negative refractive power and the outer region has a reflective coating to form folding mirror 1604 that folds the narrow channel to primary reflector 1602. FIG. 34 shows one exemplary prescription for narrow FOV channel 1618 of system 1600. FIG. 35 shows one exemplary prescription for panoramic FOV channel 1614 of system 1600.

### Applications Section

Systems 600, FIG. 6, 1300, FIG. 13, 1400, FIG. 14, and 1600, FIG. 16, provide multi-scale, wide field of view solutions that are well suited to enable capabilities such as 3D mapping, automatic detection, tracking and mechanical stabilization. In the following description, use of system 600 is discussed, but systems 1300, 1400 and 1600 may also be used in place of system 600 within these examples.

In the prior art, it is required to steer small unmanned aerial vehicles (UAVs) so that the target is maintained within the FOV of a forward looking camera (intended for navigation) or so that the target is maintain within a FOV of a side-looking higher resolution camera. Thus, the flight path of the UAV must be precisely controlled based upon the target to be acquired. A particular drawback of tracking a target with a fixed camera is a tendency for the UAV to over-fly the target when using the forward looking camera. If the UAV is following the target and the target is slow moving, the aircraft must match the target's velocity or it will over-fly the target. When the UAV does over-fly the target, reacquisition time is usually lengthy and targets are often lost. Also, targets are often lost when the UAV must perform fast maneuvers in urban environments.

### Decoupling Flight and Imaging

In one exemplary use, system 600 is included within an UAV for decoupling aircraft steering from imaging, for increasing time on target, for increasing ground covered, and for multiple displaced object tracking. The architecture of system 600 allows steering of the UAV to be decoupled from desired image capture. A target may be continually maintained within 360 degree FOV 604 and actuated mirror 616 may be selectively controlled to image the target, regardless of the UAV's heading. Thus, the use of system 600 allows the UAV to be flown optimally for the prevailing weather conditions, terrain, and airborne obstacles, while target tracking is improved. With system 600, over-fly of a target is no longer a problem, since the 360 degree FOV 604 and selectively controlled narrow FOV 602 allows a target to be tracked irrespective of the UAV's position relative to the target.

System 600 may be operated to maintain a continuous view of a target even during large position or attitude changes of its carrying platform. Unlike a gimbaled mounted camera that must be actively positioned to maintain view of the target, the 360 degree FOV 604 is continuously captured and thereby provides improved utility compared to the prior art gimbaled camera, since a panoramic image is provided without continuous activation and associated high power consumption required to continuously operate the gimbaled camera.

### Extended Time on Target

A further advantage of using system 600 within a UAV is an extended ‘time on target’, and an increased search distance. For example, when used as a push-broom imager flown at around 300 feet above ground level (AGL), the search distance in increased by a factor of three. By configuring the narrow channel of system 600 to have substantially the same resolution as a prior art side looking camera, the combination of the disclosed 360 degree FOV 604 and selectable narrow FOV 602 allows visual coverage of three times the area of ground perpendicular to the direction of travel of the UAV compared to prior art systems. This improvement is achieved by balanced allocation of resolution between the 360 degree FOV 604 (the panoramic channel), that is used for detection, and narrows FOV 602 (the narrow channel) that is used for identification. The result of the improved ground coverage has been demonstrated through a stochastic threat model showing that it takes one-third the time to find the target. This also manifests as three times the area being covered in the same amount of flight time when searching for a target.

A UAV containing a prior art side-looking camera must perform a tight sinusoidal sweep in order to minimize the area where a threat may be undetected when performing route clearance operations. By including system 600 within the UAV (e.g., in place of the prior art side-looking camera and forward looking navigation camera), the extended omni-directional ground coverage enables the UAV to take a less restricted flight pattern, such as to take a direct flight along the road, while increasing the ground area imaged in the same (or less) time.

A UAV equipped with a prior art gimbaled camera is still limited to roughly the same performance as when equipped with a prior art fixed side-looking camera, because the operation of slewing the gimbaled camera from one side of the UAV to the other would leave gaps in the area surveyed and leave the possibility of a threat being undetected.

### Multiple Target Tracking

With a prior art side-looking camera, if targets exist outside the ground area imaged by the camera, they may not be detected. Once a target is acquired, the UAV is flown to maintain the target within the FOV of the camera, and therefore other threats outside of that images area would go unnoticed. Even when the camera is gimbaled and multiple targets are tracked, one or more targets may be lost in the time it takes to slew the FOV from one threat to the next.

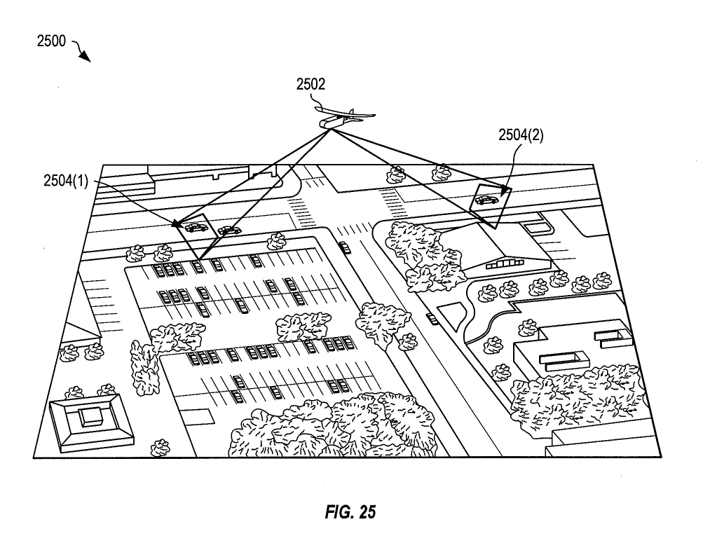

System 600 has the ability to track multiple, displaced targets (e.g., threats) by tracking more than one target simultaneously using the 360 degree FOV 604 and by acquiring each target within narrow FOV 602 as needed. FIG. 25 shows system 600 mounted within a UAV 2502 and simultaneously tracking of two targets 2504(1) and 2504(2). For example, actuated mirror 616 may be positioned to acquire a selected target within 100 milliseconds and may therefore be controlled alternately image each target 2504, while simultaneously maintaining each target within 360 degree FOV 604 of system 600.

Since system 600 continuously captures images from 360 degree FOV 604 and the narrow FOV 602 simultaneously, system 600 may interrogate any portion of a captured image very quickly with high magnification by positioning actuated mirror 616, while maintaining image capture from 360 degree FOV 604. System 600 thereby provides the critical See and Avoid (SAA) capability required for military and national unmanned aircraft system (UAS) operation. FIG. 18 is a perspective view 1800 showing one exemplary UAV 1802 equipped with system 600 of FIG. 6 showing exemplary portions of 360 degree FOV 604. Small UAVs are difficult to see on radar and track in theater, so they are flown at an altitude below 400 feet AGL to avoid manned aircraft that typically fly above 400 feet AGL. This ceiling may be increased when with the capability of small unmanned aircraft systems (SUAS) equipped with system 600 to detect an approaching aircraft using 360 degree FOV 604, target and identify the aircraft using the narrow FOV 602 within 100 milliseconds, and then to send control instructions to the auto-piloting system to avoid collision. A UAV equipped with system 600 would also enable it use in non-line-of-sight border patrol operations for Homeland Security, since the UAV would be able to detect and avoid potential collisions.

Another new capability enabled by system 600 (also referred to as “Foveated 360” herein) is persistent 360 degree surveillance on unmanned ground vehicles (UGVs) or SUAS. Vertical take-off and land aircraft are ideal platforms for mobile sit and stare surveillance. When affixed with a prior art static camera, the aircraft must be re-engaged frequently to reposition the FOV, or settle on limited field coverage. Such systems need to be very lightweight and are intended to operate for extended periods of time, which precludes the use of a heavy, power hungry gimbaled camera systems. System 600 is particularly suited to this surveillance type application by providing imaging capability for navigation and surveillance without requiring repositioning of the aircraft to change FOV.

The dual-purpose navigate and image capabilities of the invention extend beyond what is used in UAVs today. Typically there are two separate cameras—one for navigation and another for higher resolution imaging. Using the disclosed panoramic system's forward-looking portion of the wide channel for navigation (which provides the same resolution as the current prior art VGA navigation cameras), one can reduce the full payload size, weight and operational power requirement by removing the navigation camera from the vehicle system.

### Egomotion

Where a vehicle is unable to use conventional navigation techniques, such as GPS, egomotion may be used to determine the vehicles position within its 3D environment. System 600 facilitates egomotion by providing continuous imagery from 360 degree FOV 604 that enables a larger collection of uniquely identifiable features within the 3D environment to be discovered and maintained within the FOV. Particularly, 360 degree FOV 604 provides usable imagery in spite of significant platform motion. Further, narrow FOV 602 may be used to interrogate and “lock on” to single or multiple high-value features that provide precision references when the visual odometry data becomes cluttered in a noisy visual environment. Studies of visual odometry demonstrate that orthogonally oriented FOVs improve algorithmic stability over binocular vision, and thus 360 degree FOV 604 may be used for robust optical flow algorithms.

### Super Resolution

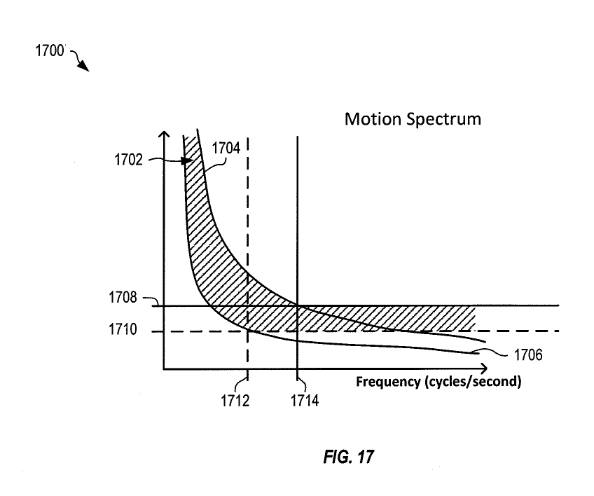

One practical limitation of video based super resolution is the optical transfer function when considering the effects of motion. There are two bounds to this problem. When there is not any motion, video based super resolution methods do not work, since they rely on sub pixel shifts between frames to improve resolution of the video image. But when the captured motion is too rapid, the resulting motion blur reduces the optical transfer function cutoff, which effectively eliminates the frequency content that is enhanced and/or recovered by super resolution algorithms. FIG. 17 is a graph 1700 of amplitude (distance) against frequency (cycles/second) that illustrates an operational super-resolution region 1702 bounded by lines 1704 and 1706 that represent constant speed. Line 1704 represents an acceptable motion blur threshold based upon blur within pixels. For example, to achieve two-times super resolution, the threshold may be a blur of half a pixel or less. Values above line 1704 have more than a half pixel blur and values below line 1704 have less than half a pixel blur. Line 1706 defines the threshold where there is enough motion to provide diversity in frame to frame images. For example, an algorithm may require at least a quarter pixel motion between frames to enable super resolution. Values below line 1706 have insufficient motion and values above line 1706 have sufficient motion. Lines 1704 and 1706 are curved because velocity is proportional to frequency and therefore to maintain constant speed over frequency the amplitude of the motion must be inversely proportional to frequency.

Changing the acceptable blur metric or exposure time will increase or decrease the area of the region with too much motion blur. The two parameters that can lower line 1706 and improve region 1702 over which super resolution is effective are the algorithm sub pixel shift requirement and the frame rate. Only within region 1702 is there sufficient motion for the algorithms and small enough motion blur to enable super resolution. Line 1708 represents a tolerable blur size that is dictated by the super resolution algorithm. As described above, the tolerable blur size may be less than a half a pixel. Line 1710 represents tolerable frame to frame motion. As described above, the super resolution algorithm may need at least a quarter-pixel motion between frames to work effectively. Line 1712 represents a system frame rate and line 1714 represents 1/exposure time. A slower frame rate (i.e., a longer frame to frame period) decreases the needed relative motion to produce a large enough pixel shift between frames, and decreasing the exposure time for each frame reduces the motion blur effects. Both of these degrees of freedom have practical limits in terms of viewed frame rate and SNR.

There are two ways to expand region 1702 where super resolution is viable based on the parameters above. The first is to decrease the exposure time during periods of rapid motion. As the exposure time goes to zero, so does motion blur. The tradeoff with taking this approach is that the SNR is also reduced with decreased exposure. During periods of low motion, the video frame rate can be decreased. Reducing the frame rate would allow more time for the camera to move relative to the scene, enabling relatively small movements to have sufficient displacement between images to satisfy the minimum required frame to frame motion condition. The tradeoff with a reduced video frame rate is an increased latency in the output video.

The actuation of mirror 616 of system 600, FIG. 6, expands the motion conditions under which super resolution may be achieved. For example actuated mirror 616 may be moved or jittered to provide displacement of the scene on image sensor 606 when natural motion is low. For fast moving objects, actuated mirror 616 may be controlled such that narrow FOV 602 tracks the moving object to minimize motion blur. Thus, through control of actuated mirror 616, the captured imagery may be optimized for super resolution algorithms.

Inevitably there are conditions where super resolution is not possible. One signal processing architecture determines the amount of platform motion either through vision based optical flow techniques or by accessing the platform's accelerometers; depending on the amount of motion, the acquired image is sent either to super resolution algorithms during low to moderate movement, or to an image enhancement algorithm under conditions of high movement. The image enhancement algorithm deconvolves the PSF due to motion blur and improves the overall image quality, improving either the visual recognition or identification task or preconditioning the data for automatic target recognition (ATR). Image enhancement is often used by commercially available super resolution algorithms. System 600 allows the option of sending several frames of images captured from narrow FOV 602 for processing at a remote location (e.g., at the base station for the UAV). The potential use of both the payload and ground station capabilities is part of the signal processing architecture facilitated by system 600.

### Enhanced SNR

System 600 may include mechanical image stabilization on one or both of the panoramic channel and the narrow channel. Where mechanical image stabilization is included within system 600 for only narrow FOV 602 (narrow channel), selective narrow FOV 602 may be used to interrogate parts of the 360 degree FOV 604 that has poor SNR. For example, where 360 degree FOV 604 generates poor imagery of shadowed areas, narrow FOV 602 may be used with a longer exposure time to images these areas, such that with mechanical stabilization of the narrow channel, the SNR of poorly illuminated areas of a scene is improved without a large decrease in the system transfer function due to motion blur.

### Stereo Configuration

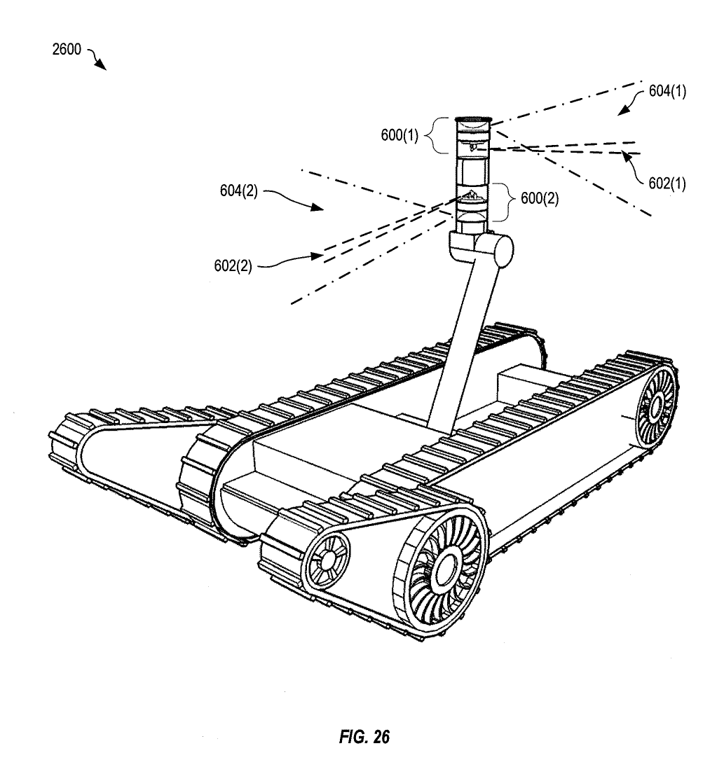

FIG. 26 shows an exemplary UGV configured with two optical systems 600(1) and 600(2) having vertical separation for stereo imaging. Systems 600(1) and 600(2) may also be mounted with horizontal separation for a more traditional stereo imaging; however each system 600 would block a portion of the 360 degree FOV 604 of other system 600. Both the separation and the magnification of each system 600 determines the range and depth accuracy provided in combination. For example, narrow FOV 602 may be used to interrogate positions in the wide field of view and provide information for distance calculation, based upon triangulation and/or stereo correspondence. For example, objects with unknown range can be identified in the wide channel and the two narrow channels with their higher magnification can be used to triangulate and increase the range resolution. This triangulation could be image based (i.e. determine the relative position of the two objects on the sensor) or could be based on feedback from the positional encoder. For objects that have a known model (i.e. points and objects with known geometry) the angular position may also be super resolved by intentionally defocusing the narrow channel and using angular super resolution algorithms such as those found in star trackers.

When coupled with a navigation system of the UGV, platform motion may also be used to triangulate a distance based a distance traveled and images taken at different times with the same aperture. This approach may enhance the depth range calculated from images from one or both of systems 600 by effectively synthesizing a larger camera separation distance.

The above systems provide other advantages, for example they allow: compact form factors, efficient use of image sensor area, and low cost solutions. In one embodiment, an imaging system is designed to meet performance, size, weight, and power specifications by utilizing a highly configurable and modular architecture. The system uses a shared sensor for both a panoramic channel and a narrow (zoom) channel with tightly integrated plastic optics that have a low mass, and includes a high speed actuated (steered) mirror for the narrow channel.

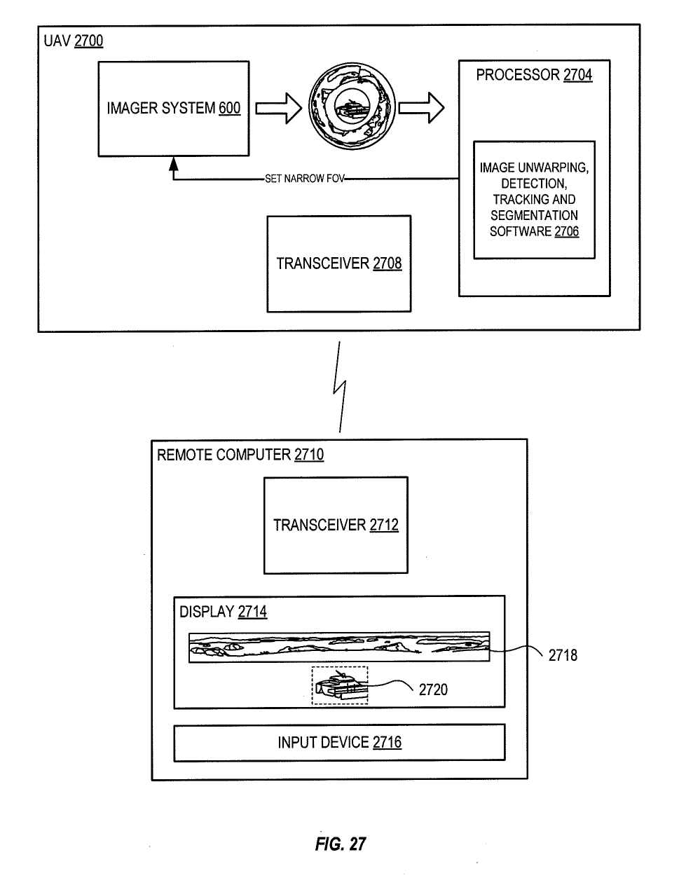

FIG. 27 is a schematic showing exemplary use of system 600, FIG. 6, within a UAV 2700 that is in wireless communication with a remote computer 2710. UAV 2700 is also shown with a processor 2704 (e.g., a digital signal processor) and a transceiver 2708. UAV 2700 may include more of fewer components without departing from the scope hereof. In one embodiment, processor 2704 is incorporated within system 600 as part of image sensor array 606 for example.

In one example of operation, system 600 sends captured video to processor 2704 for processing by software 2706. Software 2706 represents instructions, executable by processor 2704, stored within a computer readable non-transitory media. Software 2706 is executed by processor 2704 to unwarp images received from system 600, detect and track targets within the unwarped images, to control narrow FOV 602 of system 600. Software 2706 may also transmit unwarped images to a remote computer 2710 using a transceiver 2708 within UAV 2700. A transceiver within remote computer 2710 receives the unwarped images from UAV 2700 and displays them as panoramic image 2718 and zoom image 2720 on display 2714 of remote computer 2710. A user of remote computer 2710 may select one or more positions within displayed panoramic image 2718 using input device 2716, wherein selected positions are transmitted to UAV 2700 and received, via transceiver 2708, by software 2706 running on processor 2704. Software 2706 may then control narrow FOV 602 to capture images of the selected positions. Software 2706 may also include one or more algorithms for enhancing resolution of received images.

In one embodiment, processor 2704 and software 2706 are included within system 600, and software 2706 provide at least part of the above described functionality of system 600.

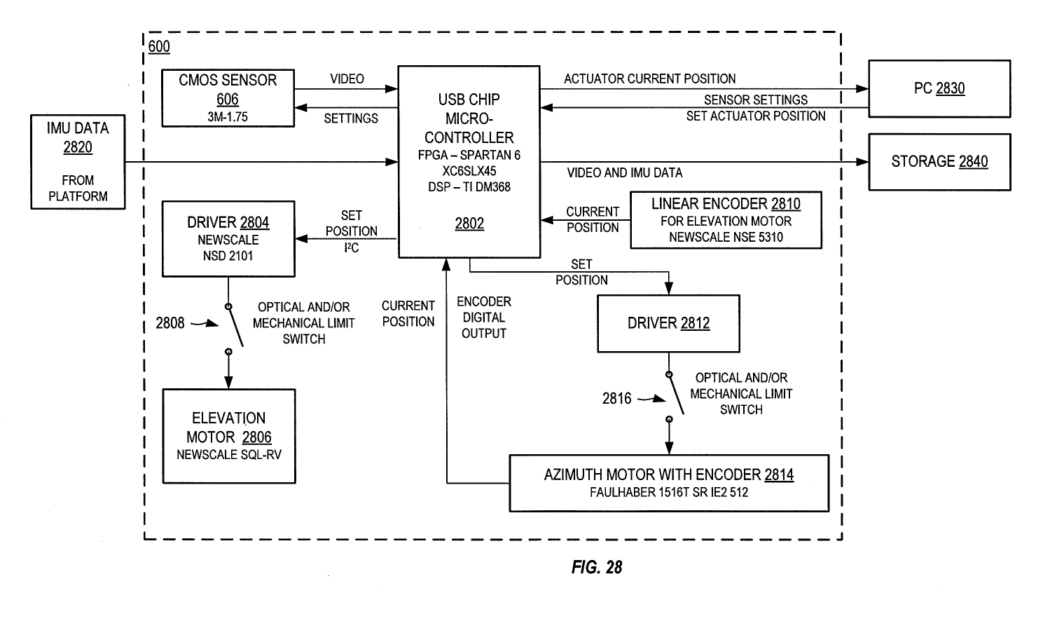

FIG. 28 is a block diagram illustrating exemplary components and data flow within imaging system 600 of FIG. 6. System 600 is shown with a microcontroller 2802 that is in communication with image sensor array 606, a driver 2804 for driving elevation motor 2806 via a limit switch 2808, a linear encoder 2810 for determining a current position of actuated mirror 616, a driver 2812 for driving an azimuth motor with encoder 2814 via a limit switch 2816. Microcontroller 2802 may receive IMU data 2820 from a platform (e.g., a UAV, UGV, unmanned underwater vehicle, and an unmanned space vehicle) supporting system 600. Microcontroller 2802 may also send current actuator position information to a remote computer 2830 (e.g., a personal computer, smart phone, or other display and input device) and receive sensor settings and actuator positions from remote computer 2830. Microcontroller 2802 may also send video and IMU data to a storage device 2840 that may be included within system 600 or remote from system 600.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system with selective narrow field of view (FOV) and 360 degree FOV, comprising:
a single sensor array;
a first optical channel for capturing a first FOV and producing a first image incident upon a first area of the single sensor array; and
a second optical channel for capturing a second FOV and producing a second image incident upon a second area of the single sensor array, the first image having higher magnification than the second image.

2. The system of claim 1, wherein the second area has an annular shape and the first area has a circular shape contained within a null zone of the second image.

3. The system of claim 1, wherein the first FOV and focal length of the first optical channel is each at least four times less than the second FOV and focal length of the second optical channel, respectively.

4. The system of claim 1, wherein the first area and the second area are substantially non-overlapping in image space.

5. The system of claim 1, further comprising a panoramic catadioptric positioned only within the second optical channel and at least one refractive lens positioned within both the first optical channel and the second optical channel.

6. The system of claim 5, further comprising at least two additional reflective surfaces in a folded configuration and positioned within the second optical channel.

7. The system of claim 1, wherein the second optical channel comprises two or more apertures imaging different parts of the second FOV.

8. The system of claim 7, further comprising, for each aperture of the second optical channel, off axis refractive optics.

9. The system of claim 7, further comprising, for each aperture of the second optical channel, a fold mirror for correcting distortion.

10. The system of claim 1, further comprising a common objective group shared by the first and second optical channels in forming the first and second images.

11. The system of claim 10, where the objective group includes a dual zone lens.

12. The system of claim 11, wherein the dual zone lens includes a zone of light blocking material.

13. The system of claim 1, wherein the first and second optical channels have f-numbers that are within half a stop of each other to equalize exposure of the optical channels onto the image sensor.

14. The system of claim 1, wherein the first FOV is in the range from 1 degree×1 degree to 20 degrees×20 degrees.

15. The system of claim 1, wherein the first FOV is in the range from 1 degree×1 degree to 50 degrees×50 degrees.

16. The system of claim 1, wherein the second FOV is in the range from 360 degrees×1 degree to 360 degrees×90 degrees.

17. The system of claim 1, wherein the single sensor array has hexagonal pixels for improving resolution for azimuth angles of the first and second FOV that are not vertically or horizontally aligned with the sensor.

18. The system of claim 17, wherein the pixels are non-uniform in area.

19. The system of claim 1, wherein the single sensor array has non-uniformly shaped pixels.

20. The system of claim 1, wherein bore sight of the second optical channel is oriented parallel to horizon.

21. The system of claim 1, wherein bore sight of the second optical channel is oriented within +/−90 degrees of a plane parallel to the horizon.

22. The system of claim 1, wherein primary mirror shape of the second optical channel is based upon orientation of the second FOV such that a tilted plane is imaged at second image with substantially constant ground sample distance (GSD) in an elevation direction.

23. The system of claim 1, wherein slant angle of the second optical channel changes as a function of azimuth angle.

24. The system of claim 5, wherein the panoramic catadioptric is actuated, segmented and/or flexed, to change slant angle.

25. The system of claim 5, wherein the panoramic catadioptric is locally actuated to create local zoom through distortion.

26. The system of claim 1, further comprising a mirror positioned within the first optical channel to select the first FOV for the first image.

27. The system of claim 26, the mirror having one or both of azimuth and elevation maneuverability.

28. The system of claim 27, wherein the maneuverability is provided by one or more actuators selected from the group of actuators including Piezo, geared, brushless, and voice coil.

29. The system of claim 27, wherein the mirror has positional encoding.

30. The system of claim 26, further comprising one or more actuators for varying power of the mirror.

31. The system of claim 30, wherein the mirror has a first side for a first set of wavelengths and a second side for a second set of wavelengths.

32. The system of claim 1, further comprising a second imaging system positioned with horizontal separation to the imaging system to provide stereo images.

33. The system of claim 32, wherein the stereo images are used to determine range by one or both of triangulation and stereo correspondence.

34. The system of claim 1, further comprising a second imaging system positioned with a vertical separation to the imaging system to provide stereo images.

35. The system of claim 34, wherein the stereo images are used to determine range by one or both of triangulation and stereo correspondence.

36. The system of claim 1, wherein the first optical channel is stabilized and uses a longer exposure time to improve low light performance.

37. The system of claim 1, further comprising an image processor for synthesizing zoom based upon one or more of variable magnification in the first optical channel, variable magnification in the second optical channel, super resolution, and interpolation between the first image and the second image.

38. The system of claim 37, wherein the image processor is remotely located from the single sensor array, the first optical channel and the second optical channel.

39. The system of claim 37, where an angle with respect to the ground horizon to an object in the first field of view is determined from the position of the object in the first image, the azimuth and elevation of the first optical channel, and an attitude of a platform supporting the imaging system.

40. The system of claim 39, wherein the attitude is determined from a navigation system of the platform.

41. The system of claim 39, further comprising a housing for mounting the imaging system within aircraft or a ground robot or an unmanned airborne vehicle or a waterborne vehicle or an underwater vehicle.

42. A system with selective narrow field of view (FOV) and 360 degree FOV, comprising:
a single sensor array;
a first optical channel including a refractive fish-eye lens for capturing a first field of view (FOV) and producing a first image incident upon a first area of the single sensor array; and
a second optical channel including catadioptrics for capturing a second FOV and producing a second image incident upon a second area of the single sensor array;
wherein the first area has an annular shape and the second area is contained within a null zone of the first area.

43. A method for imaging with selective narrow FOV and 360 degree FOV, comprising:
imaging 360 degree FOV with null zone onto a sensor array; and
imaging narrow FOV onto the null zone, the narrow FOV being selectively within the 360 degree FOV and having increased magnification as compared to the 360 degree FOV.

44. The method of claim 43, further comprising selectively steering the narrow FOV within the 360 FOV.

45. The method of claim 43, wherein each step of imaging utilizes a shared lens group having a plastic dual power optical component.

46. The method of claim 45, wherein the step of imaging 360 degree FOV comprises utilizing a panoramic catadioptric.

47. The method of claim 43, wherein the step of imaging 360 degree FOV comprises forming an annular image with the null zone it its center.

48. The method of claim 47, wherein the step of imaging narrow FOV comprises forming a circular image at the null zone, the circular image being substantially non-overlapping with the annular image.

49. The method of claim 43, further comprising actuating a mirror to steer the narrow FOV within the 360 FOV.

50. The method of claim 43, further comprising de-warping images created from the steps of imaging to provide a linear image.

51. The method of claim 43, wherein the step of imaging narrow FOV comprises selectively zooming to the increased magnification.

52. The method of claim 43, wherein the steps of imaging comprises imaging a first wavelength band onto the sensor array sensitive to the first wavelength band, and further comprising:
imaging the 360 degree FOV with LWIR null zone onto a second sensor array sensitive to LWIR; and
imaging the narrow FOV onto the LWIR null zone of the second sensor array.

53. The method of claim 52, further comprising utilizing a mirror coated on one side to reflect visible light as the first wavelength band and coated on a second side to reflect LWIR for steps of imaging in the LWIR.

54. The method of claim 43, wherein imaging 360 degree FOV comprises utilizing four 90 degree FOV optical channels each with its own aperture.

55. The method of claim 54, wherein imaging comprises contiguously imaging each 90 degree FOV into rectangles of the sensor array.

56. The method of claim 43, wherein the steps of imaging are performed within one of an unmanned airborne vehicle (UAV), an unmanned ground vehicle (UGV), an unmanned underwater vehicle, and an unmanned space vehicle.
